(19) United States
(12) Patent Application Publication
(10) Pub. No.: US 2026/0330409 A1
(43) Pub. Date: Oct. 22, 2026

(54) SYSTEM

(71) Applicant: SoftBank Group Corp., Tokyo (JP)

(72) Inventor: Ryouji NISHIMOTO, Tokyo (JP)

(73) Assignee: SoftBank Group Corp., Tokyo (JP)

(21) Appl. No.: 19/646,638

(22) Filed: Apr. 14, 2026

(30) Foreign Application Priority Data
Apr. 22, 2025 (JP) 2025-070636

(51) Int. Cl. G06Q 10/087

(52) U.S. Cl. CPC G06Q 10/08772

(57) ABSTRACT

The present invention relates to a supply chain optimization system that, in a company having a complex supply chain such as a manufacturing industry, a logistics industry, and a retail industry, automatically collects and integrates diverse data such as sales performance, inventory, production, delivery, and external environment distributedly managed in different systems and formats, constructs and optimizes a demand prediction model using generative AI, automatically drafts inventory replenishment, a production plan, and a delivery plan by a multi-objective optimization algorithm, and enables real-time analysis, report generation, abnormality detection, and interactive inquiry, and throughout the whole, automates and sophisticates data integration, demand prediction, plan optimization, security management, and decision-making support in an end-to-end manner, thereby realizing operational efficiency improvement, cost reduction, inventory optimization, rapid decision making, and competitiveness enhancement.

### CROSS-REFERENCE TO RELATED APPLICATION

The present application claims priority to and incorporates by reference the entire contents of Japanese Patent Application No. 2025-070636 filed in Japan on Apr. 22, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

The problem to be solved by the present invention includes, in a company having a complex supply chain such as a manufacturing industry, a logistics industry, and a retail industry, a problem that data integration becomes difficult, manual data conversion and input work frequently occur, and data consistency and immediacy cannot be ensured because sales performance data, inventory data, production data, delivery data, external environment data, and the like managed in different systems and different formats for each department and each base exist in a distributed and non-unified state; a problem that accuracy is low in demand prediction depending on past performance and rules of thumb, excess inventory and shortage frequently occur, and an inventory cost and a shortage loss increase; a problem that efficiency of the entire supply chain decreases and fund operation efficiency and delivery efficiency deteriorate because inventory management, a production plan, and a delivery plan are individually optimized; in addition, a problem that rapid decision making becomes difficult because real-time data collection and analysis cannot be performed, and a management layer and a site person in charge cannot immediately respond to market changes and demand fluctuations; and a problem that a security measure for centrally and safely managing data of the entire supply chain is insufficient, and a leakage risk of confidential information and personal information of the company increases, and the point is to solve these problems in an end-to-end manner by an automation and optimization technology utilizing generative AI, and achieve operational efficiency improvement, cost reduction, and competitiveness enhancement of the company by realizing data integration of the entire supply chain, improvement of demand prediction accuracy, optimization of an inventory, production, and delivery plan, real-time analysis and rapid decision making, and strict security management.

### SUMMARY OF THE INVENTION

A means for solving the problem according to the present invention is to configure a supply chain optimization system comprising: a data integration unit; a demand prediction unit; an optimization planning unit; a report generation unit; and a security management unit, wherein the data integration unit has a function of automatically collecting sales performance data, inventory data, production data, delivery data, external environment data, and the like managed in different systems and different formats in a plurality of industries such as a manufacturing industry, a logistics industry, and a retail industry, and performing standardization processing on column names, date formats, numerical units, and the like to construct a centralized integrated database; the demand prediction unit has a function of extracting feature amounts such as past sales quantities, inventory amounts, prices, seasonality, promotion histories, and external factors for each product, each base, and each date from the integrated database, and predicting future demand with high accuracy by a machine learning algorithm using generative AI; the optimization planning unit has a function of automatically executing an algorithm for optimizing an inventory replenishment plan, a production plan, and a delivery plan by the generative AI in consideration of a plurality of parameters such as a demand prediction result, a current inventory amount, an ordering lead time, a production capacity, and a delivery cost, and calculating an optimal plan that simultaneously satisfies a plurality of objective functions such as minimization of an inventory cost, suppression of a shortage risk, and maximization of delivery efficiency; the report generation unit has a function of automatically aggregating and visualizing analysis results such as a current inventory status, a future production/delivery schedule, an accuracy evaluation of demand prediction, and an abnormal value detection using the generative AI based on the integrated database and the optimization plan, and providing the analysis results in real time to a decision maker in a form of a dashboard, an automatically distributed email, or the like; the security management unit has a function of thoroughly protecting confidential information and personal information of a company by applying a strict security policy such as data access authority management, encryption, and audit log recording; and by these respective units operating in cooperation, data integration, demand prediction, optimization planning, real-time analysis, report generation, and security management of the entire supply chain are automated in an end-to-end manner, thereby realizing operational efficiency improvement, cost reduction, inventory optimization, rapid decision making, and competitiveness enhancement of the company.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor indicated by reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), among others.

In the following embodiments, a RAM (Random Access Memory) indicated by reference numeral is a memory where information is temporarily stored and used as a work memory by the processor.

In the following embodiments, a storage indicated by reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) indicated by reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

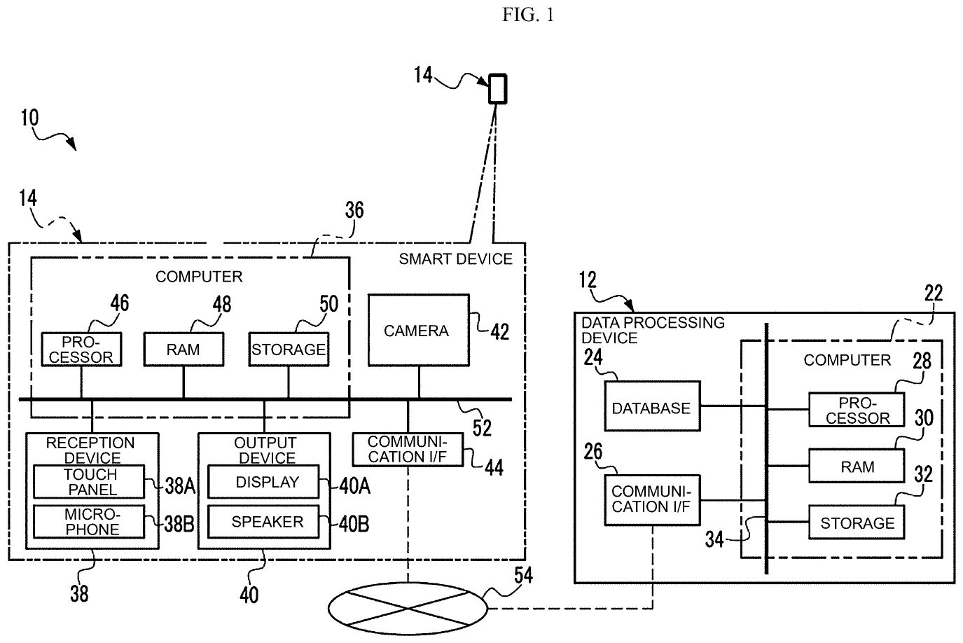

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, camera 42, and communication I/F 44 are also connected to the bus 52.

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A in the processor 46 sends data indicating user input accepted by the touch panel 38A and microphone 38B to the data processing device 12. In the data processing device 12, the specific processing unit 290 acquires data indicating user input.

The output device 40 comprises a display 40A and a speaker 40B, among others, and presents data to the user 20 by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

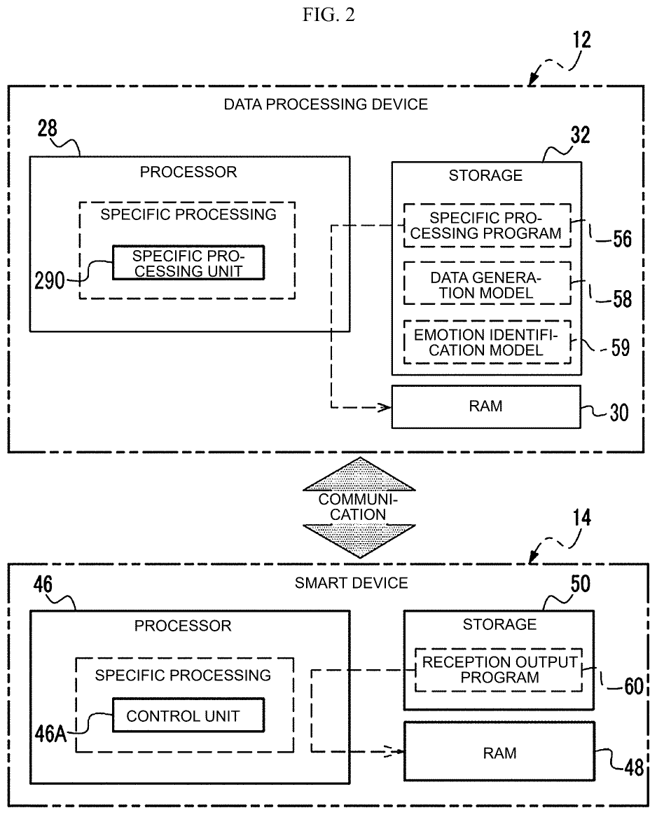

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart device 14, reception output processing is performed by the processor 46. The storage 50 stores a reception output program 60. The reception output program 60 is used in conjunction with the specific processing program 56 by the data processing system 10. The processor 46 reads the reception output program 60 from the storage 50 and executes it on the RAM 48. The reception output processing is realized by the processor 46 operating as a control unit 46A according to the reception output program 60 executed on the RAM 48. The smart device 14 may also have similar data generation models and emotion identification models as the data generation model 58 and emotion identification model 59, and perform the same processing as the specific processing unit 290 using these models. The reception output processing is realized by the processor 46 operating as the control unit 46A according to the reception output program 60 executed on the RAM 48.

Other devices besides the data processing device 12 may have the data generation model 58.

For example, a server device (e.g., a generation server) may have the data generation model 58.

In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1

The flow of the specific processing in Example 1 will be described. Each part of the system described below is realized by the data processing device 12 and the smart device 14. Additionally, the data processing device 12 is referred to as a “server,” and the smart device 14 is referred to as a “terminal.”

### Embodiment for Carrying out the Present Invention

As an embodiment for carrying out the present invention, a supply chain optimization system is realized by a cooperative operation of a server and a terminal. The server includes a data integration unit, a demand prediction unit, an optimization planning unit, a report generation unit, and a security management unit, and the terminal mainly plays roles of a user interface, data input, report browsing, notification reception, site work support, and an interactive inquiry function. Hereinafter, a configuration of each unit, processing contents, a specific utilization method of generative AI, and role sharing between the server and the terminal will be described in detail with specific examples. Specifically, the supply chain optimization system adopts an architecture that links a plurality of computing nodes in a distributed computing environment. The system executes a plurality of neural networks including a large language model and a time-series prediction model in parallel. The server includes a parallel computing cluster using a graphics processing unit. The server dynamically allocates computing resources to each processing unit. The data integration unit maps input data in heterogeneous formats to a high-dimensional tensor space. The demand prediction unit executes a transformer-type neural network including a self-attention mechanism. The optimization planning unit solves a multi-objective optimization problem using a reinforcement learning algorithm. The report generation unit converts numerical data into a text vector using a natural language processing model. The security management unit operates an autoencoder model for abnormal value detection. The terminal reduces a communication load with the server using an edge computing technology. The terminal locally preprocesses input data from a user. The system eliminates a conventional manual data aggregation work by a human through the cooperative operation of these hardware and software. The system reduces a latency of data processing to a millisecond unit. The system realizes visualization and optimization of the entire supply chain in real time. The system exhibits a technical effect of dramatically improving computing efficiency. Specific application fields of the system include optimization of a parts procurement network in a globally expanding manufacturing industry, an automatic inventory replenishment system at the time of multi-store expansion in a large-scale retail industry, and the like.

First, the data integration unit operates on the server, and automatically collects diverse data such as sales performance data, inventory data, production data, delivery data, weather data, economic indicator data, regional event data, and traffic information data from heterogeneous information systems, spreadsheet files, CSV files, cloud storages, databases, IoT sensors, external APIs, and the like used by a plurality of bases, departments, and external partners. For example, when a certain factory manages production performance in a CSV file, a logistics base manages inventory information in a spreadsheet file, and a retail store manages sales performance in a cloud-type database, the data integration unit acquires data from each data source by means such as API linkage, file upload, batch processing, and periodic acquisition by a scheduler. Furthermore, real-time data such as temperature, humidity, position information, vibration, and impact are received from the IoT sensors via MQTT or HTTP, and weather forecasts, economic indicators, traffic congestion information, regional event information, and the like are acquired from the external APIs in a JSON or XML format. Specifically, the data integration unit receives thousands of data streams per second using an asynchronous communication protocol. The data integration unit temporarily stores the received raw data in a buffer area on a memory. The data integration unit converts unstructured data into structured data using a natural language processing model. The data integration unit receives, for example, a 1000-dimensional character string vector, a 100-dimensional time-series numerical array, and a two-dimensional image tensor as input data. The data integration unit executes preprocessing of noise removal and missing value imputation on these input data. The data integration unit inputs the preprocessed data to a multilayer perceptron. The multilayer perceptron converts the input data into a common latent space vector. An output from the multilayer perceptron is, for example, a 256-dimensional floating-point vector or a probability score from zero to one indicating reliability of each data source. The data integration unit stores this output result in a database as an input tensor to the subsequent demand prediction unit. The data integration unit completely eliminates a conventional manual data input work by a human in a data collection process. The data integration unit prevents a processing error due to a mismatch of data formats. The data integration unit exhibits a technical effect of improving robustness of a data processing pipeline. Specific application fields of the data integration unit include integrated management of supply chain information in an automobile manufacturer that procures parts from a plurality of different vendors, an operation data collection system from a group of automatic transport robots equipped with a wide variety of sensors, and the like.

The data integration unit performs standardization processing on the acquired data, such as conversion of column names (for example, unifying different names such as “product code”, “product number”, and “SKU” into “product_id”), unification of date formats (for example, converting “YYYY/MM/DD”, “DD-MM-YYYY”, and the like into an ISO8601 format), conversion of numerical units (for example, unifying “kg”, “g”, “t”, and the like into “kg”), deduplication of data, missing value imputation (for example, when an inventory quantity is missing, imputing it with recent data or an estimated value by AI), and abnormal value detection and correction (for example, when a sales quantity is abnormally large, AI automatically corrects it from past trends or similar store data). Even when an unknown data format or a new data source is added, the generative AI learns past data structures and conversion rules, and automatically generates an optimal mapping and conversion logic. For example, even when a column structure of a spreadsheet file newly added from an overseas base is different from an existing one, the generative AI can automatically infer an association, normalize the data, and store the data in the integrated database. Also in data cleansing processing, the generative AI learns past correction histories and patterns, and automatically applies an optimal correction method for improving data consistency. Specifically, the data integration unit calculates semantic similarity of column names using a large language model. The data integration unit receives, for example, a token sequence of a character string, a history vector indicating a past conversion history, and a metadata array of a data type as input data. The data integration unit inputs these input data to a transformer encoder. The transformer encoder learns a dependency relationship between respective tokens using a self-attention mechanism. An output from the transformer encoder is, for example, a text vector indicating a standardized column name, a percentage score indicating a certainty factor of conversion, and an identifier of a conversion rule to be applied. The data integration unit automatically applies the conversion rule when the certainty factor score exceeds a predetermined threshold. The data integration unit transfers the data to an exception handling module when the certainty factor score is less than the threshold. The data integration unit executes a time-series prediction model using a long short-term memory network for abnormal value detection. The time-series prediction model calculates a prediction interval from past data transition. The data integration unit sets a flag as an abnormal value when an actual data value deviates from the prediction interval. The data integration unit continuously updates weights of the network by an error backpropagation method using a mean square error as a loss function. The data integration unit eliminates a conventional inefficient work in which a human visually performs data cleansing. The data integration unit exhibits a technical effect of uniforming data quality and dramatically improving inference accuracy of a subsequent machine learning model. Specific application fields of the data integration unit include construction of a data warehouse of a global retail company that integrates sales data described in different languages and unit systems around the world, a standardization system of electronic medical record data provided from a plurality of medical institutions, and the like.

Next, the demand prediction unit operates on the server, and extracts multidimensional feature amounts such as past sales quantities, inventory amounts, prices, seasonality, promotion histories, weather information, economic indicators, regional event information, traffic information, trends of competing stores, and consumer behavior data for each product, each base, and each date from the integrated database. For example, when demand for a certain product tends to increase on weekends and holidays, the generative AI automatically extracts calendar information and regional event information as feature amounts and incorporates them into a prediction model. Furthermore, when demand for a specific product rapidly increases when weather deteriorates, the generative AI learns a correlation between past weather data and sales performance, and automatically performs demand prediction using a weather forecast. As for an influence of promotion measures and price changes on demand, the generative AI also automatically extracts a causal relationship and reflects it in the model. As a demand prediction model, the generative AI automatically selects and optimizes a time-series prediction model, a deep learning model, a gradient boosting model, a mixed-effects model, and the like, and autonomously executes feature engineering and hyperparameter tuning. For example, an optimal prediction method is automatically selected according to product characteristics and base characteristics, such as applying a seasonal decomposition model to a product with large seasonal fluctuation and applying a deep learning model with an anomaly detection function to a product with many sudden demand fluctuations. A prediction result is output for each product and each base on a daily, weekly, or monthly basis, and an evaluation index of prediction accuracy (MAPE, RMSE, R2 score, etc.) is also automatically calculated. Specifically, the demand prediction unit combines the extracted multidimensional feature amounts to generate a high-dimensional feature tensor. The demand prediction unit receives, for example, a one-dimensional array indicating sales quantities for the past 365 days, a binary vector indicating presence or absence of weather and events, and an embedding vector indicating attribute information of a product as input data. The demand prediction unit normalizes these input data and inputs them to a transformer-based time-series prediction model. The time-series prediction model simultaneously captures both a long-term dependency relationship and a short-term fluctuation pattern using a multi-head attention mechanism. An output from the time-series prediction model is, for example, a floating-point array indicating daily demand prediction values for the next 30 days, upper limit and lower limit vectors indicating a confidence interval of each prediction value, and an importance score of a feature amount contributing to the prediction. The demand prediction unit writes this output result into a shared memory as input data to the optimization planning unit. In learning of the model, the demand prediction unit optimizes parameters using a gradient descent method so as to minimize an absolute error between a prediction value and a performance value. The demand prediction unit suppresses overlearning using dropout and data augmentation technologies. The demand prediction unit eliminates a conventional demand prediction method depending on human intuition and experience. The demand prediction unit mathematically processes complexly intertwined external factors, and exhibits a technical effect of significantly reducing a prediction error. Specific application fields of the demand prediction unit include an automatic ordering system for daily delivery products in a food supermarket where a short expiration date and disposal loss are issues, initial allocation optimization of new products in consideration of trend fluctuation in a fast fashion industry, and the like.

The optimization planning unit also operates on the server, and simultaneously optimizes an inventory replenishment plan, a production plan, and a delivery plan with diverse parameters such as an output result of the demand prediction unit, a current inventory amount, an ordering lead time, a production capacity, a delivery cost, a storage cost, delivery network information between respective bases, shift information of workers, an operating status of vehicles, an empty space in a warehouse, options of delivery companies, traffic congestion prediction, weather risk, and emergency response rules as inputs. For example, when a rapid increase in demand for a specific product is predicted in demand prediction, the generative AI automatically calculates how much to produce at which factory, how much to deliver to which base, and at what timing to replenish, in consideration of a production capacity, an inventory status, and a delivery lead time. In order to simultaneously satisfy a plurality of objective functions (minimization of an inventory cost, suppression of a shortage risk, maximization of delivery efficiency, improvement of fund operation efficiency, reduction of CO2 emissions, etc.), the generative AI automatically generates a multi-objective optimization algorithm (for example, an evolutionary algorithm, reinforcement learning, metaheuristics, etc.), and calculates an optimal plan in a short time under realistic constraint conditions. For example, complex planning in line with actual conditions of a site is possible, such as inventory accommodation between a plurality of bases, immediate response to sudden demand fluctuation, delivery route optimization considering options of a plurality of delivery companies, and backup planning in an emergency. After execution of the plan, performance data is continuously fed back, and the generative AI automatically updates the optimization algorithm and parameters, thereby realizing continuous improvement of plan accuracy. Specifically, the optimization planning unit solves an optimization problem under complex constraint conditions using a deep reinforcement learning algorithm. The optimization planning unit receives, for example, a demand prediction tensor output from the demand prediction unit, a state vector indicating a current inventory amount of each base, and a distance matrix of delivery routes as input data. The optimization planning unit defines these input data as a state space in a Markov decision process. The optimization planning unit executes a neural network based on a policy gradient method. An output from the neural network is, for example, an integer vector indicating a production instruction amount at each factory, a binary matrix indicating truck assignment to each delivery route, and a timestamp array indicating an ordering timing. The optimization planning unit inputs this output result to a simulation environment, and calculates an expected total cost and shortage rate. The optimization planning unit receives the calculated result as a reward signal, and updates weights of the neural network so as to maximize a reward. The optimization planning unit uses a genetic algorithm in combination to prevent falling into a local optimal solution. The optimization planning unit eliminates a conventional inefficient process in which a human manually makes a plan using spreadsheet software. The optimization planning unit derives an optimal solution from millions of combinations in a few seconds, and exhibits a technical effect of dramatically reducing an operation cost of the entire supply chain. Specific application fields of the optimization planning unit include an immediate planning system for an alternative delivery route bypassing a transportation network disrupted at the time of disaster occurrence, an automatic inventory accommodation system between warehouses in an apparel company developing a plurality of brands, and the like.

The report generation unit operates on the server, and automatically creates diverse analysis reports such as a current inventory status, a future production/delivery schedule, an accuracy evaluation of demand prediction, an abnormal value detection, a KPI progress status, a cost analysis, a risk scenario analysis, a bottleneck analysis of the entire supply chain, a CO2 emission analysis, a delivery date compliance rate, a worker operation rate, and a delivery delay risk using the generative AI based on contents of the integrated database and the optimization plan. For example, the generative AI automatically generates a report optimized for each user, such as a summary report briefly summarizing main points for a management layer, detailed work instructions and abnormality alerts for a site person in charge, detailed explanations of model accuracy and anomaly detection logic for a data scientist, and a delivery date prospect and a quality assurance report for a customer. Utilizing a natural language generation function, an analysis result can be expressed in diverse formats such as easy-to-understand sentences, graphs, heat maps, time-series charts, and visualization on a map, and provided in diverse forms such as a dashboard on the terminal side, an automatically distributed email, a chatbot notification, a PDF report, and API linkage. For example, it is possible to enable a site person in charge to receive an inventory abnormality alert on a smartphone and immediately confirm a response instruction, and to enable a management layer to browse a KPI dashboard on a notebook computer and utilize it for decision making. Specifically, the report generation unit generates a natural language text from numerical data utilizing a large language model. The report generation unit receives, for example, a plan result tensor output from the optimization planning unit, a percentage array indicating an achievement rate of KPI, and a list of anomaly detection flags as input data. The report generation unit embeds these input data into a prompt template and inputs them to a language model. The language model generates a text through an autoregressive decoding process. An output from the language model is, for example, a summary text vector for a management layer, a character string in a markdown format including specific instructions for a site, and JSON structured data for graph drawing. The report generation unit transmits this output result to a rendering engine to generate a visual dashboard and a PDF document. The report generation unit filters the generated report according to an authority level of a user. The report generation unit completely automates a conventional routine work in which a human aggregates data and creates a report. The report generation unit eliminates a transmission delay of information, and exhibits a technical effect of dramatically improving a speed of decision making. Specific application fields of the report generation unit include a business management system that automatically generates real-time management indicators for a general meeting of shareholders and a board of directors, a smart factory support system that automatically distributes an operation status of a daily production line and an improvement proposal to a factory manager every morning, and the like.

The security management unit operates on the server, and applies a strict security policy such as data access authority management, encryption, audit log recording, abnormal access detection, data masking, data backup, a disaster recovery plan, and compliance with laws and regulations such as GDPR. The generative AI realizes dynamic and autonomous security management beyond conventional static security measures, such as automatically detecting an unauthorized access pattern from an access log, dynamically optimizing access authority according to a data utilization status, and automatically identifying and warning a location with a high data leakage risk. For example, when a specific user downloads a large amount of data from a time zone or a place different from usual, the generative AI can detect an abnormal behavior and immediately issue an alert to an administrator. Specifically, the security management unit executes an anomaly detection algorithm using unsupervised learning. The security management unit receives, for example, a time-series vector of an access log including a login time and an IP address of a user, a character string tensor of an executed SQL query, and a numerical array indicating a data transfer amount as input data. The security management unit inputs these input data to an autoencoder network. The autoencoder network compresses the input data into a low-dimensional latent space, and then restores the original data. An output from the autoencoder network is, for example, a restored data vector, a reconstruction error score between the input data and the restored data, and a contribution degree vector of a feature amount that caused an abnormality. When the reconstruction error score exceeds a dynamically set threshold, the security management unit blocks the access as being suspected of a cyber attack or internal fraud. The security management unit transmits an emergency alert to a terminal of an administrator simultaneously with the blocking. The security management unit identifies an unknown attack pattern that cannot be detected by a rule-based firewall. The security management unit simultaneously ensures availability and confidentiality of the system, and exhibits a technical effect of reducing an information leakage risk to the utmost limit. Specific application fields of the security management unit include a zero trust network access system in a research and development department handling highly confidential design data of a new product, an internal fraud monitoring system in a financial institution holding a large amount of personal information of customers, and the like.

The terminal side mainly provides an interface for a user to access the system, and is used for purposes such as a site person in charge confirming and inputting an inventory status and work instructions in real time from a tablet terminal or a smartphone, and a management layer browsing KPI and a risk status on a dashboard from a notebook computer and receiving an alert notification. On the terminal side, a report and a dashboard distributed from the server are displayed, and a user can input a comment and feedback as necessary. For example, a site person in charge inputs an inventory taking result from the terminal, and the information is immediately reflected in the integrated database on the server side, whereby real-time data update becomes possible. Furthermore, in response to an inquiry or instruction in natural language from the terminal (for example, “Tell me the inventory risk of major products this week”, “Display the demand prediction for next month in a graph”, etc.), an interactive dialogue function can also be realized in which the generative AI on the server side automatically executes optimal data extraction and analysis processing, and returns an easy-to-understand answer and report to the terminal side. Specifically, the terminal side adopts a single page application architecture, and performs asynchronous communication with the server. The terminal side receives, for example, an integer value of an inventory quantity input by a user via a touch panel, a voice waveform tensor acquired from a voice recognition microphone, and an image matrix of a barcode acquired from a camera as input data. The terminal side executes lightweight preprocessing locally on these input data. The terminal side transmits the preprocessed data to the server through an encrypted communication channel. The terminal side receives, for example, a JSON object indicating an updated inventory status, a text vector instructing a work to be performed next, and a parameter array for voice synthesis from an interactive agent as an output from the server. The terminal side immediately renders this output result on a graphical user interface. The terminal side provides a part of functions even in an offline environment using a local cache. The terminal side eliminates a conventional analog method in which a human transmits information using a paper slip. The terminal side eliminates an information gap between a site and a management department, and exhibits a technical effect of dramatically improving real-time property of business. Specific application fields of the terminal side include a wearable device linkage system for a worker who performs a picking work while moving in a vast logistics warehouse, a business support application for a retail store manager who performs an ordering work using a smartphone in a backyard of a store, and the like.

In addition, data such as temperature, humidity, and position information acquired in real time from IoT sensors are also automatically collected and integrated on the server side, and the generative AI can utilize these data to predict, for example, a quality deterioration risk of fresh products and a delivery delay risk, and automatically distribute an alert to the terminal side as necessary. For example, when a temperature of a refrigerated warehouse exceeds a set value, the generative AI can immediately determine a quality deterioration risk and automatically transmit an emergency response instruction to a terminal of a site person in charge. Specifically, the server side receives high-frequency sensor data transmitted from an edge device by a stream processing engine. The server side receives, for example, a floating-point array of temperature sampled at one-second intervals, a two-dimensional vector of latitude and longitude indicating GPS coordinates, and a vibration tensor from a three-axis acceleration sensor as input data. The server side divides these input data by a sliding window method, and inputs them to a convolutional neural network. The convolutional neural network extracts a local feature pattern from time-series data. An output from the convolutional neural network is, for example, a sigmoid score from zero to one indicating a probability of quality deterioration, an integer value indicating delay minutes of an estimated arrival time, and a coordinate vector indicating a predicted position of abnormality occurrence. When the quality deterioration probability exceeds a specified threshold, the server side automatically generates a control command for an air conditioning facility. The server side transmits the generated command to a control unit of a corresponding transport vehicle. The server side eliminates a conventional monitoring work in which a human periodically checks a thermometer. The server side instantaneously responds to a physical environmental change, and exhibits a technical effect of preventing a disposal loss of a product. Specific application fields of the server side include a cold chain transport monitoring system for pharmaceuticals requiring strict temperature management, an impact detection and route change instruction system during transport of precision machinery, and the like.

Furthermore, for example, when performing data linkage among a plurality of supply chain partners, the generative AI automatically learns differences in data formats and business processes of respective companies, and generates an optimal data conversion and linkage logic, thereby realizing rapid and safe data sharing. For example, delivery date information and quality information from an overseas supplier can be automatically captured and immediately reflected in a domestic production and inventory plan. Specifically, the system trains a model without taking raw data of each partner company to the outside using a federated learning technology. The system receives, for example, a character string vector of order data described in an EDI format unique to a partner company, a natural language text describing business rules of each company, and a matrix of a past data mapping history as input data. The system inputs these input data to a graph neural network. The graph neural network expresses a transaction relationship between companies by nodes and edges, and models propagation of information. An output from the graph neural network is, for example, a conversion matrix between different formats, a probability distribution tensor indicating a correspondence relationship of data items, and an automatically generated source code snippet for API linkage. The system dynamically constructs a data conversion pipeline using this output result. The system records the converted data in a blockchain network to ensure tamper resistance. The system eliminates enormous system development man-hours when performing system integration between companies. The system exhibits a technical effect of increasing transparency of the entire supply chain and significantly shortening a lead time of inter-company linkage. Specific application fields of the system include digitalization of a procurement network in a major assembly manufacturer having a large number of small and medium-sized suppliers, an automatic digitalization system of customs procedures and trade documents in international logistics, and the like.

As described above, in the embodiment of the present invention, the server side mainly realizes each unit of data integration, demand prediction, optimization planning, report generation, and security management, and utilizes the generative AI as an essential element for automation, optimization, and sophistication processing of each unit, and the terminal side realizes a user interface, data input/browsing, a notification function, an interactive dialogue function, and the like, thereby automating and sophisticating data integration, demand prediction, plan optimization, real-time analysis, report generation, and security management of the entire supply chain in an end-to-end manner, and realizing operational efficiency improvement, cost reduction, inventory optimization, rapid decision making, and competitiveness enhancement of a company. Specifically, the present system containerizes each processing unit as a microservice architecture, and dynamically scales it using an orchestration tool. The present system operates a meta AI model that supervises the entire system. The present meta AI model receives, as input data, for example, a numerical vector indicating a CPU usage rate of each processing unit, a time-series array indicating a traffic amount of a network, and a throughput indicator of the entire system. The present meta AI model inputs these input data to a reinforcement learning agent. An output from the present reinforcement learning agent is, for example, an integer matrix indicating a resource allocation amount to each container, a weight vector indicating a priority of processing, and a restart command for eliminating a bottleneck. The present system autonomously optimizes a system configuration based on this output result. The present system completely eliminates manual system tuning and resource management work by a human. The present system exhibits a technical effect of maintaining stable performance even against sudden access concentration and an increase in data amount. Specific application fields of the present system include backend processing optimization of an e-commerce platform during a large-scale sale such as Black Friday, autonomous operation of an integrated core business system of a multinational company expanding on a global scale, and the like.

### System Configuration

The system according to the present embodiment includes a data integration unit, a demand prediction unit, an optimization planning unit, a report generation unit, a security management unit, a user interface unit, and an interactive inquiry unit. The data integration unit automatically collects diverse data such as sales performance data, inventory data, production data, delivery data, weather data, economic indicator data, regional event data, and traffic information data from heterogeneous information systems, spreadsheet files, CSV files, cloud storages, databases, IoT sensors, external APIs, and the like used by respective bases and departments in a manufacturing industry, a logistics industry, a retail industry, and the like, and external partners. For example, a CSV file of production performance managed in a factory, a spreadsheet file of inventory information managed in a logistics base, a cloud-type database of sales performance managed in a retail store, temperature/humidity/position information from an IoT sensor, a weather forecast and an economic indicator from an external API, traffic congestion information, and the like are collected by means such as API linkage, file upload, batch processing, periodic acquisition by a scheduler, real-time reception via MQTT or HTTP, and data acquisition in a JSON or XML format. The data integration unit performs standardization processing such as conversion of column names, unification of date formats, conversion of numerical units, deduplication of data, missing value imputation, and abnormal value detection/correction on the acquired data, and automatically generates an optimal mapping and conversion logic by utilizing the generative AI to learn past data structures and conversion rules even when an unknown data format or a new data source is added. For example, when a column structure of a spreadsheet file newly added from an overseas base is different from an existing one, the generative AI automatically infers an association, normalizes the data, and stores the data in the integrated database. Also in data cleansing processing, the generative AI learns past correction histories and patterns, and automatically applies an optimal correction method for improving data consistency. Specific examples of a prompt sentence to be read by the generative AI include “Please normalize the following inventory data in different formats for the integrated database. Please also automatically perform association of column names, unification of date formats, conversion of numerical units, missing value imputation, and abnormal value detection and correction.” and the like. Specifically, the present data integration unit combines the input prompt sentence and target data, and inputs them to a context window of a large language model. The present data integration unit receives, as input data, for example, a 500-dimensional embedding vector obtained by tokenizing the prompt sentence, a two-dimensional character string matrix expressing target raw CSV data, and a subset of a knowledge graph storing past normalization rules. The present data integration unit inputs these input data to an encoder-decoder model based on a transformer architecture. The present model calculates a relevance between an instruction content of the prompt and each element of the input data using an attention mechanism. An output from the present model is, for example, a structured text in a JSON format storing normalized data, a natural language vector explaining a conversion logic of each column, and an index array of records detected as abnormal values. The present data integration unit passes this output result to a parser, and automatically generates an insert statement to the database. The present data integration unit executes the generated insert statement, and updates the integrated database. The present data integration unit eliminates conventional programming work in which a human manually writes a data conversion script. The present data integration unit flexibly adapts even to an unknown data format, and exhibits a technical effect of dramatically reducing an initial introduction cost of data integration. Specific application fields of the present data integration unit include a data integration project of heterogeneous systems accompanying a corporate acquisition, an automatic collection platform for external open data whose format may be changed daily, and the like.

The demand prediction unit extracts multidimensional feature amounts such as past sales quantities, inventory amounts, prices, seasonality, promotion histories, weather information, economic indicators, regional event information, traffic information, trends of competing stores, and consumer behavior data for each product, each base, and each date from the integrated database, automatically extracts and selects factors affecting demand using the generative AI, and automatically generates and optimizes a time-series prediction model or a deep learning model. For example, for a product whose demand increases on weekends and holidays, calendar information and regional event information are extracted as feature amounts, for a product whose demand rapidly increases when weather deteriorates, demand prediction using a weather forecast is performed, and an influence of a promotion measure or a price change on demand is also reflected in the model as a causal relationship. The generative AI automatically selects an optimal prediction method according to product characteristics and base characteristics, and autonomously executes feature engineering and hyperparameter tuning. For example, a seasonal decomposition model is applied to a product with large seasonal fluctuation, and a deep learning model with an abnormal value detection function is applied to a product with many sudden demand fluctuations. Specific examples of a prompt sentence to be read by the generative AI include “Please predict demand for each product, each base, and each date based on the following sales performance data, inventory data, weather data, and event data. Please automatically extract factors affecting demand and generate an optimal prediction model.” and the like. Specifically, the present demand prediction unit activates an automated machine learning pipeline in accordance with an instruction based on the prompt sentence. The present demand prediction unit receives, as input data, for example, a data frame of millions of rows including the extracted multidimensional feature amounts, a metadata vector indicating a data type of each feature amount, and a threshold of a mean absolute error which is a target indicator of optimization. The present demand prediction unit inputs these input data to a feature selection algorithm. The present algorithm calculates an importance of each feature amount using a random forest. An output from the present algorithm is, for example, a selected top 50 feature index array, a floating-point vector indicating a contribution degree of each feature amount, and a hyperparameter group of the generated prediction model. The present demand prediction unit constructs a long short-term memory network using this output result, and executes learning. The present demand prediction unit infers future demand using the learned model. The present demand prediction unit eliminates conventional specialized work in which a data scientist manually performs feature engineering and model selection. The present demand prediction unit autonomously reconstructs the model following an environmental change, and exhibits a technical effect of always keeping prediction accuracy at the highest level. Specific application fields of the present demand prediction unit include a production planning system of a beverage manufacturer whose demand suddenly changes depending on weather and SNS trends, a dispatch prediction system of a taxi company that dynamically changes the number of dispatched vehicles according to a holding status of a regional event, and the like.

The optimization planning unit simultaneously optimizes an inventory replenishment plan, a production plan, and a delivery plan with diverse parameters such as an output result of the demand prediction unit, a current inventory amount, an ordering lead time, a production capacity, a delivery cost, a storage cost, delivery network information between respective bases, shift information of workers, an operating status of vehicles, an empty space in a warehouse, options of delivery companies, traffic congestion prediction, a weather risk, and an emergency response rule as inputs. For example, it is possible to automatically formulate a production/delivery plan for a product whose demand is predicted to rapidly increase, and formulate a complex plan in line with actual conditions of a site, such as inventory accommodation between a plurality of bases, immediate response to sudden demand fluctuation, delivery route optimization considering options of a plurality of delivery companies, and backup plan formulation in an emergency. The generative AI automatically generates a multi-objective optimization algorithm, and calculates an optimal plan in a short time under realistic constraint conditions. After execution of the plan, performance data is continuously fed back, and the generative AI automatically updates the optimization algorithm and parameters. Specific examples of a prompt sentence to be read by the generative AI include “Please automatically generate an optimal inventory replenishment plan, production plan, and delivery plan that simultaneously satisfy minimization of an inventory cost, suppression of a shortage risk, and maximization of delivery efficiency based on the following demand prediction data, inventory data, production capacity, delivery cost, lead time, and network information.” and the like. Specifically, the present optimization planning unit analyzes an instruction of the prompt sentence, and automatically defines an objective function and a constraint condition of a multi-objective optimization problem as a mathematical model. The present optimization planning unit receives, as input data, for example, a multidimensional tensor indicating a demand prediction value of each base, an adjacency matrix indicating a graph structure of a delivery network, and an integer vector indicating a loading capacity of each vehicle. The present optimization planning unit encodes these input data as an initial population of an evolutionary algorithm. The present evolutionary algorithm searches for a solution using crossover and mutation operators. An output from the present evolutionary algorithm is, for example, a multidimensional array indicating a set of Pareto optimal solutions, an evaluation value vector indicating a tradeoff between an inventory cost and a delivery cost in each solution, and a coordinate list of a specific delivery route based on the selected optimal solution. The present optimization planning unit passes this output result to a simulator, and verifies feasibility of the plan. The present optimization planning unit transmits the plan that has passed the verification to a control system of each base. The present optimization planning unit eliminates a conventional planning method in which a human performs partial optimization based on an empirical rule. The present optimization planning unit derives a total optimal solution with a bird's-eye view of the entire supply chain, and exhibits a technical effect of dramatically reducing a total operation cost. Specific application fields of the present optimization planning unit include an integrated planning system of a major consumer goods manufacturer having a plurality of factories and hundreds of distribution centers, an emergency logistics system that efficiently delivers relief supplies at the time of a disaster with limited vehicles, and the like.

The report generation unit automatically creates diverse analysis reports such as a current inventory status, a future production/delivery schedule, an accuracy evaluation of demand prediction, an abnormal value detection, a KPI progress status, a cost analysis, a risk scenario analysis, a bottleneck analysis of the entire supply chain, a CO2 emission analysis, a delivery date compliance rate, a worker operation rate, and a delivery delay risk using the generative AI based on the integrated database and contents of the optimization plan. For example, a report optimized for each user is automatically generated, such as a summary report briefly summarizing main points for a management layer, detailed work instructions and abnormality alerts for a site worker, a detailed explanation of model accuracy and an abnormal value detection logic for a data scientist, and a delivery date prospect and a quality assurance report for a customer. Utilizing a natural language generation function, analysis results are expressed in diverse formats such as easy-to-understand sentences, graphs, heat maps, time-series charts, and visualization on a map, and provided in diverse forms such as a dashboard, an automatically distributed email, a chatbot notification, a PDF report, and API linkage. Specific examples of a prompt sentence to be read by the generative AI include “Please automatically generate a summary report for a management layer and a work instruction report for a site worker based on the following optimization plan data, inventory data, and KPI data. Please express analysis results in an easy-to-understand manner with graphs and sentences.” and the like. Specifically, the present report generation unit sets a text generation parameter according to a persona of a target reader in accordance with an instruction of the prompt sentence. The present report generation unit receives, as input data, for example, a numerical matrix indicating a simulation result of the optimization plan, a floating-point vector indicating a difference between a target value and a performance value of a KPI, and an identifier array of a base that is a bottleneck. The present report generation unit dynamically inserts these input data into a prompt of a large language model. The present large language model controls diversity of output by adjusting a temperature parameter. An output from the present large language model is, for example, a high-level summary text vector for a management layer, a bulleted list including specific action items for a site, and a JSON object including a setting parameter for a graph drawing library. The present report generation unit inputs this output result to an HTML rendering engine, and generates a visual report. The present report generation unit automatically distributes the generated report via an email server. The present report generation unit eliminates conventional clerical work in which a human extracts data from a plurality of systems and compiles a report. The present report generation unit exhibits a technical effect of providing information of an optimal granularity to a decision maker in each layer while maintaining freshness of information. Specific application fields of the present report generation unit include a management dashboard system that automatically reports a company-wide supply chain status for a monthly board of directors meeting, a store operation support system that automatically transmits personnel assignment and ordering instructions for the next day to a store manager of each store, and the like.

The security management unit applies a strict security policy such as data access authority management, encryption, audit log recording, abnormal access detection, data masking, data backup, a disaster recovery plan, and legal compliance. The generative AI realizes dynamic and autonomous security management, such as automatically detecting an unauthorized access pattern from an access log, dynamically optimizing access authority according to a data usage status, and automatically identifying and warning a location with a high data leakage risk. For example, when a specific user downloads a large amount of data from a time zone or a location different from usual, the generative AI detects an abnormal behavior and immediately issues an alert to an administrator. Specific examples of a prompt sentence to be read by the generative AI include “Please analyze the following access log data and automatically detect unauthorized access and abnormal behavior. Please identify a high-risk location and automatically generate an alert sentence to an administrator.” and the like. Specifically, the present security management unit activates a dedicated neural network for log analysis based on an instruction of the prompt sentence. The present security management unit receives, as input data, for example, a two-dimensional tensor obtained by vectorizing an access log of the past 24 hours, an embedding vector indicating a normal behavior profile of each user, and a hash value array of a known attack signature. The present security management unit inputs these input data to a recurrent neural network. The present recurrent neural network learns a change in a time-series behavior pattern. An output from the present recurrent neural network is, for example, a probability score from zero to one indicating an abnormality degree of each access session, a contribution degree vector of a feature amount indicating a reason determined as abnormal, and a text vector constituting an alert sentence for an administrator. When the probability score exceeds a threshold, the present security management unit forcibly terminates a session of the corresponding user. The present security management unit push-notifies the generated alert sentence to a smartphone of the administrator. The present security management unit eliminates conventional unrealistic security operation in which a human visually monitors a huge amount of logs. The present security management unit takes a defense measure in real time even against an unknown threat, and exhibits a technical effect of dramatically improving robustness of the system. Specific application fields of the present security management unit include a zero-trust security system that monitors access to an integrated database constructed on a cloud environment, an internal information leakage countermeasure system that prevents a large amount of downloading of confidential data by a person scheduled to retire, and the like.

The user interface unit provides an interface for a site worker to confirm/input an inventory status and work instructions in real time from a tablet terminal or a smartphone, and for a management layer to browse a KPI and a risk status on a dashboard from a notebook computer and receive an alert notification. For example, a site worker inputs an inventory taking result from a terminal, and the information is immediately reflected in the integrated database, whereby real-time data update becomes possible. The user interface unit displays a report and a dashboard distributed from the server, and allows a user to input a comment and feedback as necessary. Specific examples of a prompt sentence to be read by the generative AI include “Please generate a work instruction screen for a site worker based on the following user input data. Please also display an alert and advice in real time according to an input content.” and the like. Specifically, the present user interface unit generates a dynamic web component in real time in accordance with an instruction of the prompt sentence. The present user interface unit receives, as input data, for example, a GPS coordinate vector indicating a current position of a user, an integer array indicating a screen resolution of a terminal, and a latest inventory data tensor acquired from a backend. The present user interface unit inputs these input data to a frontend rendering engine. The present rendering engine efficiently updates only a difference of a screen using a virtual DOM. An output from the present rendering engine is, for example, a tree structure of optimized HTML elements, a CSS animation parameter for attracting user's attention, and a text vector of a pop-up message warning an input error. When a user inputs data, the present user interface unit immediately executes validation of an input value. The present user interface unit dynamically changes a display color on the screen based on a validation result. The present user interface unit eliminates a conventional rigid system interface in which a human performs an operation in accordance with a fixed screen layout. The present user interface unit adaptively provides an optimal operation environment according to a user's situation and an input content, and exhibits a technical effect of reducing an input mistake and improving work efficiency. Specific application fields of the present user interface unit include an in-warehouse work support system that displays characters largely for a tablet terminal installed in a driver's seat of a forklift, an in-factory production management system that automatically translates and displays an interface language for a foreign worker speaking multiple languages, and the like.

The interactive inquiry unit provides an interactive dialogue function in which the generative AI on the server side automatically executes optimal data extraction and analysis processing in response to an inquiry and an instruction in a natural language from a terminal, and returns an easy-to-understand answer and report to the terminal side. For example, when a management layer inputs “Tell me an inventory risk of main products this week”, “Display a demand prediction for next month in a graph”, or the like, the generative AI extracts and analyzes related data, and immediately generates and replies a risk report and a graph summarizing main points. Specific examples of a prompt sentence to be read by the generative AI include “Please answer a risk factor and a countermeasure in an easy-to-understand sentence based on latest inventory data and demand prediction data in response to a question from a user ‘Tell me an inventory risk this week’.” and the like. Specifically, the present interactive inquiry unit combines the prompt sentence and the user's question, and executes a retrieval-augmented generation architecture. The present interactive inquiry unit receives, as input data, for example, a character string vector obtained by textifying a voice input of a user, a context matrix of related data retrieved from the integrated database, and an embedding vector indicating a past question history of the user. The present interactive inquiry unit inputs these input data to a large language model. The present large language model generates an answer by combining external knowledge and an internal parameter. An output from the present large language model is, for example, a text vector indicating a direct answer to a question, a JSON object for graph drawing of underlying data, and a command array proposing an action to be performed next. The present interactive inquiry unit passes this output result to a voice synthesis engine, generates a natural voice waveform, and reproduces it from a speaker of the terminal. The present interactive inquiry unit eliminates a conventional specialized operation in which a human writes a complex SQL query to extract information from a database. The present interactive inquiry unit provides an intuitive interface by a natural language, and exhibits a technical effect that even a non-engineer can instantly access an advanced data analysis result. Specific application fields of the present interactive inquiry unit include an executive support system in which an executive asks a latest sales prediction by voice during a management meeting and immediately obtains an answer, a customer service support system in which a store staff performs inventory confirmation through a smart watch while dealing with a customer, and the like.

As described above, in the system according to the present embodiment, respective units operate in cooperation with each other, and the generative AI is utilized as an essential element for automation, optimization, and sophistication processing of each unit, thereby automating and sophisticating data integration, demand prediction, plan optimization, real-time analysis, report generation, security management, a user interface, and an interactive inquiry of the entire supply chain in an end-to-end manner, and realizing operational efficiency improvement, cost reduction, inventory optimization, rapid decision making, and competitiveness enhancement of a company. Specifically, the present system adopts an event-driven architecture, and asynchronously links data between respective units via a message queue. The present system operates an integrated control module that monitors a data flow of the entire system. The present integrated control module receives, as input data, for example, a numerical array in milliseconds indicating a latency of each processing unit, an integer vector indicating the number of retentions in a message queue, and a floating-point tensor indicating an error rate of the entire system. The present integrated control module inputs these input data to an autoencoder for abnormal value detection. An output from the present autoencoder is, for example, a health score indicating soundness of the entire system, an identifier of a component that is a bottleneck, and a control command vector for triggering automatic recovery processing. The present system autonomously adjusts dynamic allocation of calculation resources and a parallelism degree of processing based on this output result. The present system completely eliminates conventional siloed system operation in which a human manually monitors and operates linked batch processing between systems. The present system seamlessly integrates information transmission from upstream to downstream of a supply chain, and exhibits a technical effect of maximizing an adaptive capacity of a company to a market change. Specific application fields of the present system include a next-generation supply chain platform that reproduces and optimizes all processes from procurement of raw materials to delivery to an end consumer on a digital twin, an autonomous operation system of a data linkage platform across a plurality of companies, and the like.

### Implementation Steps

Step 1: Data Collection/Integration Step In this step, diverse data such as sales performance data, inventory data, production data, delivery data, weather data, economic indicator data, regional event data, and traffic information data are automatically collected from heterogeneous information systems, spreadsheet files, CSV files, cloud storages, databases, IoT sensors, external APIs, and the like used by respective bases and departments such as a manufacturing industry, a logistics industry, and a retail industry, and external partners. For example, a CSV file of production performance managed in a factory, a spreadsheet file of inventory information managed in a logistics base, a cloud-type database of sales performance managed in a retail store, temperature/humidity/position information from an IoT sensor, a weather forecast, an economic indicator, and traffic congestion information from an external API, and the like are collected by means such as API linkage, file upload, batch processing, periodic acquisition by a scheduler, real-time reception via MQTT or HTTP, and data acquisition in a JSON or XML format. Specifically, in this step, the system deploys a distributed data collection agent to an edge server of each base. The system receives, as input data, for example, a floating-point array of temperature transmitted every second from each sensor, a character string tensor indicating a transaction log of a database, and weather data in a JSON format acquired from an external API. The system executes data compression and filtering processing on these input data on the edge side. The system transfers the processed data to a central data lake via a secure virtual private network. The system processes a data stream in the data lake using an open-source distributed messaging system or the like. An output from the system is, for example, a group of files in a Parquet format converted into a standardized format, a catalog index storing metadata of each data, and a status code array indicating a success rate of data collection. The system provides this output result as an input of a subsequent machine learning pipeline. The system eliminates a conventional analog data collection method in which a human physically moves data using a USB memory or an email. The system exhibits a technical effect of shortening a time lag from data collection to integration to a millisecond unit and constructing a real-time data analysis platform. Specific application fields of this step include construction of a data platform for a global manufacturing industry that collects operation data in real time from thousands of factories scattered all over the world, an environmental data integration system from millions of IoT devices in a smart city, and the like.

Step 2: Data Standardization/Cleansing Step In this step, standardization processing such as conversion of column names, unification of date formats, conversion of numerical units, deduplication of data, missing value imputation, and abnormal value detection/correction is performed on the collected data. Even when an unknown data format or a new data source is added, an optimal mapping and conversion logic is automatically generated by learning past data structures and conversion rules utilizing generative AI. For example, when a column structure of a spreadsheet file newly added from an overseas base is different from an existing one, the generative AI automatically infers an association, and normalizes and stores the data in the integrated database. Specific examples of a prompt sentence to be read by the generative AI include “Please normalize the following inventory data in different formats for the integrated database. Please also automatically perform association of column names, unification of date formats, conversion of numerical units, missing value imputation, and abnormal value detection and correction.” and the like. Specifically, the data integration unit inputs the collected raw data to a natural language processing model. The system acquires a character string vector and a token array of a header row of a spreadsheet file as input data. The system uses, for example, a 512-dimensional embedding vector as the input data. The system inputs character string tokens such as “product code”, “quantity”, and “date” as a specific example. The natural language processing model calculates a semantic similarity between column names using a self-attention mechanism. The model generates a mapping probability distribution to a standardized column name as output data. The model outputs numerical values such as a probability of 0.95 to “product ID” and a probability of 0.98 to “quantity” as a specific example. The system executes automatic mapping when the probability exceeds a preset threshold as subsequent processing. The system transmits the corresponding data to an exception queue when the probability falls below the threshold. The system executes fine-tuning using a past mapping history as teacher data. The system updates a weight of a neural network using a cross-entropy error function. The system eliminates a manual mapping work for an unknown format. The system dramatically improves a processing speed of data integration. The system improves accuracy of data management.

Step 3: Demand Prediction Model Generation/Execution Step In this step, multidimensional feature amounts such as past sales quantities, inventory amounts, prices, seasonality, promotion histories, weather information, economic indicators, regional event information, traffic information, trends of competing stores, and consumer behavior data are extracted for each product, each base, and each date from the integrated database, factors affecting demand are automatically extracted and selected using generative AI, and a time-series prediction model and a deep learning model are automatically generated and optimized. For example, for a product whose demand tends to increase on weekends and holidays, calendar information and regional event information are extracted as feature amounts, for a product whose demand rapidly increases when weather deteriorates, demand prediction using a weather forecast is performed, and an influence of a promotion measure and a price change on demand is also reflected in the model as a causal relationship. Specific examples of a prompt sentence to be read by the generative AI include “Please predict demand for each product, each base, and each date based on the following sales performance data, inventory data, weather data, and event data. Please automatically extract factors affecting demand and generate an optimal prediction model.” and the like. Specifically, the demand prediction unit constructs a recurrent neural network or a time-series conversion model in order to process time-series data. The system generates a multidimensional time-series tensor combining past sales quantities, weather data, and event flags as input data. The system inputs a tensor having a shape of a batch size, past 30 days, and 50 dimensions of feature amounts as a specific example. The system includes elements such as a normalized numerical value of temperature, a precipitation probability, and a holiday flag in the input data. The neural network learns a temporal dependency relationship. The model sequentially updates a hidden state vector. The model generates a continuous value vector of demand prediction values for a specific future period as output data. The model outputs an upper limit value and a lower limit value indicating a confidence interval of each prediction value. The system outputs the number of daily sales predictions for 7 days from the next day as an integer value as a specific example. The system transmits the prediction value vector as an input of the optimization planning unit as subsequent processing. The system applies the prediction value vector as a calculation reference for an inventory replenishment amount. The system predicts nonlinear demand fluctuation with high accuracy. The system simultaneously reduces a shortage risk and excess inventory. The system realizes calculation efficiency improvement of the entire supply chain.

Step 4: Inventory/Production/Delivery Plan Optimization Step In this step, an inventory replenishment plan, a production plan, and a delivery plan are simultaneously optimized with diverse parameters such as an output result of the demand prediction unit, a current inventory amount, an ordering lead time, a production capacity, a delivery cost, a storage cost, delivery network information between respective bases, shift information of workers, an operating status of vehicles, an empty space in a warehouse, options of delivery companies, traffic congestion prediction, a weather risk, and an emergency response rule as inputs. The generative AI automatically generates a multi-objective optimization algorithm, and calculates an optimal plan in a short time under realistic constraint conditions. For example, it is possible to automatically formulate a production/delivery plan for a product whose demand is predicted to rapidly increase, and formulate a complex plan in line with actual conditions of a site, such as inventory accommodation between a plurality of bases, immediate response to sudden demand fluctuation, delivery route optimization considering options of a plurality of delivery companies, and backup plan formulation in an emergency. Specific examples of a prompt sentence to be read by the generative AI include “Please automatically generate an optimal inventory replenishment plan, production plan, and delivery plan that simultaneously satisfy minimization of an inventory cost, suppression of a shortage risk, and maximization of delivery efficiency based on the following demand prediction data, inventory data, production capacity, delivery cost, lead time, and network information.” and the like. Specifically, the optimization planning unit executes a reinforcement learning model or a genetic algorithm. The system constructs a state space tensor including a demand prediction vector, a current inventory amount vector, a production capacity matrix, and a delivery cost matrix as input data. The system inputs an integer value indicating the number of inventories at each base and a floating-point number indicating a delivery lead time between bases as a specific example. The reinforcement learning model simulates an action in which an agent selects a production amount and a delivery amount. The model defines a sum of a negative value of an inventory cost and a shortage penalty as a reward function. The model updates a weight of a policy network so as to maximize the reward function. The model generates an action vector indicating an optimal production amount and delivery amount for each base and each product as output data. The system outputs an instruction matrix for delivering 100 pieces of a product X from a factory A to a base B as a specific example. The system converts the action vector into a control command as subsequent processing. The system automatically transmits the control command to a production management system and a delivery management system of each base. The system executes multi-objective optimization at high speed in a high-dimensional space. The system formulates an optimal supply chain plan while suppressing consumption of calculation resources.

Step 5: Report Generation/Visualization Step In this step, diverse analysis reports such as a current inventory status, a future production/delivery schedule, an accuracy evaluation of demand prediction, an abnormal value detection, a KPI progress status, a cost analysis, a risk scenario analysis, a bottleneck analysis of the entire supply chain, a CO2 emission amount analysis, a delivery date compliance rate, a worker operation rate, and a delivery delay risk are automatically created using generative AI based on contents of the integrated database and the optimization plan. For example, a report optimized for each user is automatically generated, such as a summary report briefly summarizing main points for a management layer, detailed work instructions and abnormality alerts for a site person in charge, a detailed explanation of model accuracy and an abnormality detection logic for a data scientist, and a delivery date prospect and a quality assurance report for a customer. Specific examples of a prompt sentence to be read by the generative AI include “Please automatically generate a summary report for a management layer and a work instruction report for a site person in charge based on the following optimization plan data, inventory data, and KPI data. Please express analysis results in an easy-to-understand manner with graphs and sentences.” and the like. Specifically, the report generation unit executes a large language model specialized for natural language generation. The system acquires a structured data array including an output vector of the optimization plan, a difference vector between a current value and a target value of a key performance indicator, and an abnormality detection flag as input data. The system inputs a numerical value of 0.85 indicating a probability of inventory shortage and a numerical value of plus 2 hours indicating a predicted time of delivery delay as a specific example. The language model embeds the structured data into a prompt template. The model sequentially generates text tokens through a decoder network. The model generates a text character string in a natural language as output data. The model generates a parameter set for drawing a graph. The system outputs definition data of a line graph in which an X-axis is a date and a Y-axis is an inventory amount as a specific example. The system transmits the generated text and graph parameters to a rendering engine as subsequent processing. The system dynamically generates a report file in a hypertext format or a portable document format. The system instantaneously converts complex numerical data into a format that a human can intuitively understand. The system prevents a delay in decision making and improves operational efficiency.

Step 6: Security Management/Audit Step In this step, a strict security policy such as data access authority management, encryption, audit log recording, abnormal access detection, data masking, data backup, a disaster recovery plan, and legal and regulatory compliance is applied. The generative AI realizes dynamic and autonomous security management, such as automatically detecting an unauthorized access pattern from an access log, dynamically optimizing an access authority according to a data usage status, and automatically identifying and warning a location with a high data leakage risk. For example, when a specific user downloads a large amount of data from a time zone or a location different from usual, the generative AI detects an abnormal behavior and immediately issues an alert to an administrator. Specific examples of a prompt sentence to be read by the generative AI include “Please analyze the following access log data and automatically detect unauthorized access and abnormal behavior. Please identify a high-risk location and automatically generate an alert sentence to an administrator.” and the like. Specifically, the security management unit executes an autoencoder-type neural network for abnormality detection. The system generates a feature amount vector combining an access time of a user, an embedding vector of an IP address, a download data amount, and an access frequency as input data. The system inputs a 256-dimensional numerical vector as a specific example. The system includes a normalized value indicating an access flag at 2:00 a.m. or a data transfer amount 100 times that in a normal state in the input data. The neural network compresses the input vector into a low-dimensional latent space. The model calculates a reconstruction error in a process of restoring data from the latent space to an original dimension. The model generates an abnormality score for each access event as output data. The system outputs a continuous value from 0.0 to 1.0 as a specific example. The system determines whether or not the abnormality score exceeds a dynamically set threshold as subsequent processing. The system forcibly disconnects the corresponding session when the threshold is exceeded. The system transmits an emergency alert packet to a terminal of the administrator. The system blocks an unknown cyber attack and internal fraud in real time. The system minimizes an information leakage risk and improves robustness of the entire system.

Step 7: User Interface/Interactive Inquiry Step In this step, an interface is provided for a site person in charge to confirm and input an inventory status and a work instruction in real time from a tablet terminal or a smartphone, and for a management layer to browse a KPI and a risk status on a dashboard from a notebook personal computer and receive an alert notification. An interactive interactive function is provided in which, in response to an inquiry or an instruction in a natural language from a terminal, the generative AI on the server side automatically executes optimal data extraction and analysis processing, and returns an easy-to-understand answer and report to the terminal side. For example, when “Tell me an inventory risk of main products this week”, “Display a demand prediction for next month in a graph”, or the like is input, the generative AI extracts and analyzes related data, and immediately generates and returns a risk report and a graph summarizing main points. Specific examples of a prompt sentence to be read by the generative AI include “Please answer a question from a user ‘Tell me an inventory risk this week’ with an easy-to-understand sentence about a risk factor and a countermeasure based on the latest inventory data and demand prediction data.” and the like. Specifically, the interactive inquiry unit executes a large language model adopting a retrieval-augmented generation architecture. The system generates a text embedding vector obtained by converting a natural language query from a user as input data. The system inputs a 768-dimensional dense vector as a specific example. The system uses a vector representation of a character string “inventory risk this week” as the input data. The language model calculates a cosine similarity between the input vector and a document vector in a vector database. The model extracts a highly relevant context. The model executes inference processing by combining the extracted context and the original query. The model generates a token string of an answer text as output data. The model outputs reference link information of a data source serving as a basis. The system streaming-displays the answer text on the user interface as subsequent processing. The system simultaneously activates a related graph widget. The system provides access to an advanced data analysis result to a user who does not have a direct search skill of a database. The system shortens an information search time and dramatically improves operational efficiency.

### Specific Use Case

For example, when the supply chain optimization system of the present invention is used in a consumer goods manufacturer having a plurality of factories, logistics bases, and retail stores, first, production performance and raw material inventory are managed by a CSV file in each factory, inventory information and warehousing/delivery history are managed by a spreadsheet file in a logistics base, sales performance and over-the-counter inventory are managed by a cloud-type database in a retail store, temperature/humidity/position information in a warehouse is collected in real time by an IoT sensor, and a weather forecast, an economic indicator, regional event information, traffic congestion information, and the like are acquired from an external API. The data integration unit automatically collects data from these different formats and systems through API linkage, file upload, periodic batch processing, real-time reception via MQTT or HTTP, data acquisition in a JSON or XML format, and the like, and performs standardization processing such as unification of column names, conversion of date formats, conversion of numerical units, deduplication of data, missing value imputation, and abnormal value detection/correction. For example, when a column structure of a spreadsheet file newly added from an overseas factory is different from an existing one, the generative AI receives a prompt “Please normalize the following inventory data in different formats for the integrated database. Please also automatically perform association of column names, unification of date formats, conversion of numerical units, missing value imputation, and abnormal value detection and correction.”, automatically generates an optimal mapping and conversion logic, and normalizes and stores the data in the integrated database. Specifically, the data integration unit adopts a distributed processing architecture that links an edge computing environment and a cloud environment. The system acquires time-series waveform data streamed from a sensor as input data. The system inputs a temperature and humidity tensor with a 100-millisecond cycle as a specific example. The system acquires meteorological data from an external interface as input data. The system executes a lightweight convolutional neural network on an edge device. The edge model performs noise removal and feature extraction. The system executes a large language model on a cloud to perform schema matching. The model generates a normalized multidimensional database record as output data. The system outputs structured data including a unified time stamp, a standardized base identifier, and an interpolated sensor value as a specific example. The system loads the normalized data into an in-memory database as subsequent processing. The system maintains a state capable of responding to a high-speed query from a subsequent demand prediction model. The system reduces consumption of a communication band in an integration process of heterogeneous mixed data. The system minimizes latency of data processing and improves a response speed of the entire system.

The demand prediction unit extracts multidimensional feature amounts such as past sales quantities, inventory amounts, prices, seasonality, promotion histories, weather information, economic indicators, regional event information, traffic information, trends of competing stores, and consumer behavior data for each product, each base, and each date from the integrated database, and automatically extracts and selects factors affecting demand and automatically generates and optimizes a time-series prediction model or a deep learning model based on a prompt for the generative AI: “Please predict demand for each product, each base, and each date based on the following sales performance data, inventory data, weather data, and event data. Please automatically extract factors affecting demand and generate an optimal prediction model.” For example, for a product whose demand increases on weekends and holidays, calendar information and regional event information are extracted as feature amounts, for a product whose demand rapidly increases when weather deteriorates, demand prediction using a weather forecast is performed, and an influence of a promotion measure or a price change on demand is also reflected in the model as a causal relationship. The generative AI automatically selects an optimal prediction method according to product characteristics and base characteristics, and autonomously executes feature engineering and hyperparameter tuning. Specifically, the demand prediction unit executes an ensemble learning architecture combining a plurality of prediction models. The system generates a composite tensor combining a past sales performance vector, a promotion flag matrix, and an embedding vector of weather information as input data. The system inputs an array of sales quantities for the past 365 days, a continuous value of precipitation, and a categorical variable of a holiday as a specific example. The system independently executes a gradient boosting decision tree and a long short-term memory network. The system weight-combines outputs of both using a meta-learner. The model generates a daily predicted sales quantity for each product and each base as output data. The model outputs a variance value indicating uncertainty of prediction. The system outputs the predicted sales quantity as an integer value and outputs the variance value as a floating-point number as a specific example. The system transmits the predicted sales quantity and the variance value to the optimization planning unit as subsequent processing. The system uses these numerical values as dynamic calculation parameters for safety stock. The system learns a complex demand fluctuation pattern that cannot be captured by a single model with high accuracy. The system significantly reduces a prediction error and improves accuracy of inventory management.

The optimization planning unit automatically generates a multi-objective optimization algorithm and calculates an optimal plan in a short time under realistic constraint conditions based on a prompt for the generative AI: “Please automatically generate an optimal inventory replenishment plan, production plan, and delivery plan that simultaneously satisfy minimization of an inventory cost, suppression of a shortage risk, and maximization of delivery efficiency based on the following demand prediction data, inventory data, production capacity, delivery cost, lead time, and network information,” with diverse parameters such as an output result of the demand prediction unit, a current inventory amount, an ordering lead time, a production capacity, a delivery cost, a storage cost, delivery network information between respective bases, shift information of workers, an operating status of vehicles, an empty space in a warehouse, options of delivery companies, traffic congestion prediction, a weather risk, and an emergency response rule as inputs. For example, it is possible to automatically formulate a production and delivery plan for a product whose demand is predicted to rapidly increase, and formulate a complex plan in line with actual conditions of a site, such as inventory accommodation between a plurality of bases, immediate response to a sudden demand fluctuation, delivery route optimization considering options of a plurality of delivery companies, and backup plan formulation in an emergency. After execution of the plan, performance data is continuously fed back, and the generative AI automatically updates the optimization algorithm and parameters. Specifically, the optimization planning unit executes a mixed integer linear programming solver and a deep reinforcement learning agent in a hybrid manner. The system acquires a probability distribution tensor of demand prediction, an inventory capacity constraint vector of each base, and a cost matrix of a transport route as input data. The system inputs an integer value indicating a maximum storable number of a base A and a numerical value indicating a truck transport unit price of a route B as a specific example. The reinforcement learning agent searches an initial heuristic solution space. The agent provides a promising initial solution to the mixed integer linear programming solver. The solver accelerates a search for an exact solution based on the provided initial solution. The system generates an optimal ordering amount vector at each time step as output data. The system outputs an operation schedule matrix of a production line and a vehicle allocation routing array of a truck. The system transmits the output schedule matrix to a manufacturing execution system of each factory as subsequent processing. The system applies the schedule matrix as an automatic control command for equipment. The system solves a large-scale supply chain optimization problem prone to combinatorial explosion. The system formulates a highly accurate plan within a practical calculation time and improves calculation efficiency.

The report generation unit automatically creates diverse analysis reports such as a current inventory status, a future production/delivery schedule, an accuracy evaluation of demand prediction, an abnormal value detection, a KPI progress status, a cost analysis, a risk scenario analysis, a bottleneck analysis of the entire supply chain, a CO2 emission amount analysis, a delivery date compliance rate, a worker operation rate, and a delivery delay risk based on contents of the integrated database and the optimization plan, based on a prompt for the generative AI: “Please automatically generate a summary report for a management layer and a work instruction report for a site person in charge based on the following optimization plan data, inventory data, and KPI data. Please express analysis results in an easy-to-understand manner with graphs and texts.” For example, a report optimized for each user is automatically generated, such as a summary report briefly summarizing main points for the management layer, a detailed work instruction and an abnormality alert for the site person in charge, a detailed explanation of model accuracy and abnormality detection logic for a data scientist, and a delivery date prospect and a quality assurance report for a customer. Utilizing a natural language generation function, the analysis results are expressed in diverse formats such as easy-to-understand texts, graphs, heat maps, time-series charts, and visualization on a map, and provided in diverse forms such as a dashboard, an automatically distributed email, a chatbot notification, a PDF report, and API linkage. Specifically, the report generation unit executes a multimodal generative artificial intelligence model. The system acquires a multidimensional numerical matrix output from the optimization planning unit as input data. The system uses a floating-point array indicating a time-series transition of a key performance indicator as input data. The system inputs transition data of an inventory turnover rate of each base and a predicted value of a carbon dioxide emission amount as a specific example. The model converts numerical data into a latent representation by an encoder. The model supplies the latent representation to both a text decoder and an image generation decoder as a context vector. The model generates a summary text for the management layer as character string data as output data. The model outputs a heat map image visually indicating a bottleneck of the supply chain as a pixel tensor. The system integrates the generated text and image as subsequent processing. The system binds the integrated data to a user interface component of the dashboard. The system executes asynchronous push distribution to a client terminal. The system converts an enumeration of enormous numerical data into intuitive visual information and natural language explanation. The system significantly reduces human cognitive load and improves a speed of information transmission.

The security management unit applies a strict security policy such as data access authority management, encryption, audit log recording, abnormal access detection, data masking, data backup, a disaster recovery plan, and legal and regulatory compliance, and realizes dynamic and autonomous security management, such as automatically detecting an unauthorized access pattern from an access log, dynamically optimizing an access authority according to a data usage status, and automatically specifying and warning a location with a high data leakage risk, based on a prompt for the generative AI: “Please analyze the following access log data and automatically detect unauthorized access and abnormal behavior. Please specify a high-risk location and automatically generate an alert text to an administrator.” Specifically, the security management unit executes a threat detection model using a graph neural network. The system generates directed graph structure data having a user, a device, and access destination data as nodes and an access history as an edge as input data. The system inputs a job title identifier of the user and a physical address of the device as node feature amounts as a specific example. The system inputs an access time and the number of transferred bytes as edge feature amounts. The neural network aggregates information of neighboring nodes and updates an embedding vector of each node. The model learns a topology of a normal access pattern. The model generates an abnormality probability score for each access event as output data. The system outputs a floating-point number from 0.0 to 1.0 as a specific example. The model outputs an importance weight of a node contributing to a risk factor. The system determines whether or not the abnormality probability score exceeds a prescribed threshold value as subsequent processing. The system immediately invalidates a session token of the corresponding user when the threshold value is exceeded. The system dynamically updates a blocking rule of a firewall. The system detects a distributed cyberattack, which is difficult to discriminate from a single log entry, as a topology change of a graph structure with high accuracy.

A user interface unit and an interactive inquiry unit provide an interface for a site person in charge to confirm and input an inventory status and a work instruction in real time from a tablet terminal or a smartphone, and for a management layer to browse a KPI and a risk status on a dashboard from a notebook personal computer and receive an alert notification, and provide an interactive dialog function of automatically executing optimal data extraction and analysis processing and returning an easy-to-understand answer and report to a terminal side in response to an inquiry and an instruction in natural language from the terminal, based on a prompt for the generative AI on a server side: “Please answer a risk factor and a countermeasure in an easy-to-understand text based on the latest inventory data and demand prediction data in response to a question from a user ‘Please tell me an inventory risk of this week’.” Specifically, the interactive inquiry unit executes a pipeline integrating a voice recognition model and a natural language understanding model. The system acquires voice waveform data acquired from a microphone of a user terminal as input data. The system inputs pulse code modulation data of 16 kilohertz sampling as a specific example. The system uses a voice signal “Please tell me an out-of-stock product in zone B” as input data. The voice recognition model converts the voice waveform into a mel-frequency cepstrum coefficient and textifies it. The natural language understanding model extracts an intent and a named entity from the text. The model generates the extracted intent label and named entity vector as output data. The system outputs an intent label “inventory inquiry” and a named entity of a target zone “B” as a specific example. The model outputs a token sequence of the generated response text. The system dynamically generates a database search query based on the intent label and the named entity vector as subsequent processing. The system embeds a search result in the response text and outputs it to a speaker or a display of the terminal. The system realizes intuitive system operation hands-free. The system reduces an input load of a site worker and improves immediacy of information access.

As described above, the supply chain optimization system of the present invention can realize operational efficiency improvement, cost reduction, inventory optimization, rapid decision making, and competitiveness enhancement of the entire supply chain by cross-sectionally integrating a plurality of bases, a plurality of operations, and diverse data sources, and integrally providing highly accurate demand prediction and optimization planning using the generative AI, real-time report generation, dynamic security management, an intuitive user interface, and an interactive inquiry function. Specifically, the system is implemented as a microservice architecture constructed on a cloud computing environment. The system acquires an event payload transmitted and received via an asynchronous messaging queue between respective subsystems as input data. The system inputs structured data indicating a new data arrival event and a prediction completion event as a specific example. The orchestration engine dynamically allocates an inference task of each artificial intelligence model onto a containerized parallel computing cluster. The engine autonomously controls load balancing and scaling. The system generates health check metrics indicating an operating status of the entire system as output data. The system outputs a numerical value in milliseconds of a usage rate of a central processing unit and an inference latency as a specific example. The system increases or decreases the number of instances of an auto-scaling group based on the metrics as subsequent processing. The system continuously executes resource optimization. The system executes large-scale and complex supply chain optimization processing while eliminating waste of calculation resources. The system realizes highly available and low-latency system operation and improves computer technology itself.

(Application Example 1) The flow of the specific processing in Application Example 1 will be described. Each part of the system described below is realized by the data processing device 12 and the smart device 14. Additionally, the data processing device 12 is referred to as a “server,” and the smart device 14 is referred to as a “terminal.”

### Embodiment for Carrying Out the Present Invention

As an embodiment for carrying out the present invention, a logistics center operation optimization system is composed of a server, a plurality of site terminals, transport robots, IoT sensors, an external information linkage interface, and the like, and respective components operate in high coordination. The server includes a data integration unit, a demand prediction unit, an optimization planning unit, a report generation unit, and a security management unit, and the site terminal is composed of a tablet, a smartphone, a personal computer, and the like used by a worker and an administrator. The transport robot includes diverse types such as an autonomous traveling type, a line traveling type, and a collaborative type, and the IoT sensor includes diverse sensing devices for temperature, humidity, vibration, illuminance, noise, air quality, position information, weight, door opening/closing, full/empty information of an inventory shelf, and the like. The external information linkage interface acquires traffic information, weather information, operation information of a delivery company, order information from a customer, delivery date information from a supplier, inventory information of an external warehouse, promotion information, event information, and the like by API, EDI, file linkage, or the like. Specifically, the logistics center operation optimization system adopts a digital twin architecture that replicates an event in a physical space to a digital space in real time. The system acquires three-dimensional point cloud data acquired from a light detection and ranging sensor of the transport robot as input data. The system acquires environmental time-series data as input data. The system inputs an array indicating current position coordinates of the robot and a distance vector to an obstacle as a specific example. A spatial recognition model on the edge server analyzes the point cloud data to detect a dynamic obstacle. An integrated model on the cloud models a status of the entire center in combination with the environmental data. The model generates a three-dimensional voxel map of the logistics center constructed on the digital space as output data. The model outputs a congestion degree score in each voxel. The system outputs the congestion degree score indicated by an integer value from 0 to 100 as a specific example. The system provides the voxel map and the congestion degree score to the optimization planning unit as subsequent processing. The system uses these data as basic data for collision avoidance route calculation of the transport robot. The system reproduces a dynamic change of the physical logistics center inside a computer with high accuracy. The system dramatically improves accuracy of optimization calculation of robot control and worker assignment.

The data integration unit automatically collects and integrates data from diverse data sources inside and outside the logistics center in real time or in batches. For example, inventory data for each zone is acquired in real time from a barcode reader, an RFID reader, an inventory management system, a picking cart, and an AGV (automated guided vehicle), and a warehousing and delivery history is acquired from a WMS (warehouse management system) and a TMS (transport management system) by API linkage. An operating status, a current position, a remaining battery level, failure information, and an operation history of the transport robot are acquired from a robot management system and a robot main body via MQTT and REST API. A shift and an operating status of a worker, a work start/end time, work contents, and a qualification, skill, health condition, and fatigue level of the worker are acquired from a site terminal and a wearable device. Delivery schedule data from the outside and order data from a customer are automatically acquired by EDI, Web API, and FTP file linkage, and traffic information and weather information are periodically acquired from an external service API. Environmental data such as temperature, humidity, vibration, illuminance, noise, air quality, position information, weight, door opening/closing, and full/empty information of an inventory shelf are collected in real time from the IoT sensor via MQTT and HTTP. For example, when a temperature abnormality is detected from a temperature sensor in a refrigerated zone, the data is immediately transmitted to the server and utilized for early detection of a quality risk. The data integration unit performs automatic conversion of column names, units, and date formats, deduplication, missing value imputation, and abnormal value detection on these heterogeneous data, and even when an unknown data format or a new data source is added, the generative AI learns a past data structure and a conversion rule, and automatically generates an optimal mapping and conversion logic. For example, when a column structure of a spreadsheet file newly added from an overseas base is different from an existing one, the generative AI automatically infers an association, normalizes it, and stores it in the integrated database. Also in data cleansing processing, the generative AI learns a past correction history and pattern, and automatically applies an optimal correction method for improving data consistency. For example, when an inventory quantity is an abnormal value, the AI automatically corrects it with reference to a past tendency and data of a similar zone. Specifically, the data integration unit executes a data pipeline linked with a stream processing engine. The system acquires a stream of unstructured and semi-structured data transmitted at high frequency from various sensors and systems as input data. The system inputs a pair of a tag identifier and a timestamp from a radio frequency identification reader as a specific example. The system uses a battery voltage value from the automated guided vehicle as input data. The abnormality detection model executes noise removal on the stream data in real time. The autoregressive moving average model performs interpolation of a missing value. The large language model analyzes a schema of a new data source and calculates a mapping vector with a schema of the existing integrated database. The model generates a tensor of structured data for which cleansing and normalization have been completed as output data. The model outputs a reliability score of each data point. The system outputs a reliability score of 0.99 as a specific example. The system inserts data having a reliability score equal to or greater than a threshold value into a data warehouse as subsequent processing. The system routes data less than the threshold value to an isolated area for relearning. The system eliminates a bottleneck in processing enormous and non-uniform sensor data. The system always guarantees high-quality and latest input data for a subsequent artificial intelligence model.

The demand prediction unit operates on the server, and extracts multidimensional feature amounts such as past shipping performance, inventory transition, order tendency, seasonality, weather, traffic conditions, promotion history, event information, competitive trend, and consumer behavior data for each product, each zone, and each date from the integrated database. For example, when demand for a specific product tends to increase on weekends and holidays, the generative AI automatically extracts calendar information and regional event information as feature amounts and incorporates them into a prediction model. Furthermore, when demand for a specific product rapidly increases when weather deteriorates, the generative AI learns a correlation between past weather data and shipping performance, and automatically performs demand prediction using a weather forecast. The generative AI also automatically extracts a causal relationship of an influence of a promotion measure or a price change on demand and reflects it in the model. As a demand prediction model, the generative AI automatically selects and optimizes a time-series prediction model, a deep learning model, a gradient boosting model, a mixed-effects model, and the like, and autonomously executes feature engineering and hyperparameter tuning. For example, an optimal prediction method is automatically selected according to product characteristics and zone characteristics, such as applying a seasonal decomposition model to a product with large seasonal fluctuation and applying a deep learning model with an abnormality detection function to a product with many sudden demand fluctuations. A prediction result is output for each product and each zone on a daily, weekly, and monthly basis, and an evaluation index of prediction accuracy (MAPE, RMSE, R2 score, etc.) is also automatically calculated. For example, the AI automatically extracts an individual demand pattern, such as a beverage whose demand rapidly increases on weekends, a raincoat whose demand increases when weather deteriorates, and a new product whose demand jumps during a promotion period, and reflects it in the prediction model. Specifically, the demand prediction unit executes a spatiotemporal graph convolutional network capable of simultaneously learning spatial and temporal features. The system generates graph structure data having each zone as a node and a physical distance and a flow line between zones as an edge as input data. The system inputs a spatiotemporal tensor to which past shipping performance and weather data are added as feature amounts. The system inputs an array of the number of shipments for the past 7 days as a node feature amount as a specific example. The system inputs a moving time between zones as an edge feature amount. The graph convolutional layer extracts a spatial dependency such as an influence of a spread of inventory decrease in an adjacent zone. The temporal convolutional layer learns a temporal fluctuation pattern such as a shipping peak for each day of the week. The model generates a predicted shipping amount matrix for each future time step for each zone and each product as output data. The model outputs a probability distribution tensor indicating a certainty factor of prediction. The system transmits the predicted shipping amount matrix to the optimization planning unit as subsequent processing. The system applies the predicted shipping amount matrix as an input parameter for an advance picking instruction and an inventory rearrangement plan. The system realizes highly accurate demand prediction considering a spatial interaction in the logistics center that cannot be captured by simple time-series prediction. The system prevents retention of work and improves processing efficiency.

The optimization planning unit operates on the server, and simultaneously optimizes inventory arrangement optimization, transport route optimization, worker assignment optimization, and shipping order optimization with diverse parameters such as an output result of the demand prediction unit, a current inventory amount, an operating status of transport robots, a shift of workers, an empty space in each zone, a shipping deadline time, a congestion status of a transport route, a remaining battery level of a robot, a skill and fatigue level of a worker, a qualification of a worker, a type and capacity of a transport robot, a work history of a worker, and an emergency response rule as inputs. For example, when a rapid increase in shipping of a specific product is predicted by demand prediction, the generative AI automatically adjusts inventory arrangement, a transport plan, and worker assignment, and calculates in real time which product is arranged in which zone and how much, which transport work is assigned to which transport robot, and which picking or packing work is assigned to which worker. In order to simultaneously satisfy a plurality of objective functions (maximization of transport efficiency, leveling of work load, prevention of shortage and retention, rapid response at the time of abnormality, reduction of CO2 emission amount, etc.), the generative AI automatically generates a multi-objective optimization algorithm (for example, an evolutionary algorithm, reinforcement learning, metaheuristics, etc.) and calculates an optimal plan in a short time under realistic constraint conditions. For example, flexible optimization in line with actual conditions of a site becomes possible, such as assigning short-distance transport work when the battery of the transport robot is low, automatically proposing a break when the fatigue level of the worker is high, and cooperatively assigning a plurality of robots and a plurality of workers when a sudden large order occurs. Furthermore, when a failure of the transport robot or a sudden absence of the worker occurs, the generative AI immediately automatically generates an alternative plan and redistributes an instruction to the site. After execution of the plan, performance data is continuously fed back, and the generative AI automatically updates the optimization algorithm and parameters, thereby realizing continuous improvement of plan accuracy. Specifically, the optimization planning unit executes a multi-agent deep reinforcement learning algorithm. The system acquires a state vector indicating a current state of the entire logistics center as input data. The system inputs current position coordinates of each transport robot and a percentage of a remaining battery level as a specific example. The system includes a current position and a task completion status of each worker in the input data. The reinforcement learning model simulates a plurality of virtual agents imitating respective robots and workers. The model sets maximization of total throughput of the entire center and minimization of a total moving distance as a shared reward function. The agent updates its own policy using a network and learns a cooperative action. The model generates a waypoint array of next destination coordinates for each transport robot as output data. The model outputs an assignment matrix of a picking list for each worker. The system transmits the waypoint array to a robot control server to control motor driving of a physical robot as subsequent processing. The system transmits the assignment matrix to the site terminal to update a work instruction screen. The system calculates highly cooperative operation in real time in a dynamically changing complex site environment. The system maximizes throughput of the entire logistics center and improves operational efficiency.

The report generation unit operates on the server, and automatically creates diverse analysis reports such as a current inventory status, a transport plan, a worker assignment, a shipping schedule, an abnormality detection result, KPI progress, transport efficiency, a work load, a delay risk, a CO2 emission amount, a worker operating rate, a transport robot operating rate, and a delivery date compliance rate using the generative AI based on contents of the integrated database and the optimization plan. For example, a specific work instruction such as “transport from zone A to zone C is assigned to robot R1 this morning, and worker W2 is in charge of picking in a shipping area” is automatically generated for a site person in charge, and an operation summary such as “transport efficiency of this week is improved by 10% compared to the previous week, a delay risk is reduced, and the number of abnormality occurrences is zero” is automatically distributed to an administrator. Utilizing a natural language generation function, the analysis result is expressed in diverse formats such as easy-to-understand sentences, graphs, heat maps, time-series charts, and visualization on a map, and is provided in diverse forms such as a dashboard, an automatically distributed email, a chatbot notification, a PDF report, and API linkage. For example, a transition of the operating rate of the transport robot is displayed in a graph, and when abnormal stops frequently occur, a cause analysis and a countermeasure plan thereof are automatically generated. Specifically, the report generation unit executes a generative artificial intelligence based on a conversion model specialized in conversion from data to text. The system acquires a multidimensional array of key performance indicators output from the optimization planning unit as input data. The system uses an alert flag vector from an abnormality detection model as input data. The system inputs a numerical value of 85.5 percent indicating an average operating rate of the transport robot and a numerical value of plus 15 minutes indicating a picking delay time in a specific zone as specific examples. The model analyzes the input numerical data using a self-attention mechanism. The model infers a causal relationship between numerical values, such as that a cause of a decrease in the operating rate is a delay in a specific zone. The model generates a logical sentence structure. The model generates text data of an analysis report described in a natural language as output data. The model outputs a graph drawing code in a vector graphics format for visualization. The system dynamically generates a hypertext document by combining the text data and the drawing code as subsequent processing. The system executes push distribution to a web browser of the administrator. The system eliminates time for a human to manually create a report from a huge amount of log data. The system dramatically improves the speed of cause investigation and decision making when an abnormality occurs.

The security management unit operates on the server, and applies a strict security policy such as data access authority management, encryption, audit log recording, abnormal access detection, data masking, data backup, a disaster recovery plan, and legal and regulatory compliance. The generative AI realizes dynamic and autonomous security management, such as automatically detecting an unauthorized access pattern from an access log, dynamically optimizing access authority according to a data usage status, and automatically identifying and warning a location with a high data leakage risk. For example, when a specific user downloads a large amount of data from a time zone or a location different from usual, the generative AI detects an abnormal behavior and immediately issues an alert to the administrator. Furthermore, when a sign of a cyber attack from the outside or an internal unauthorized access is detected, the AI automatically executes an access restriction or data blocking to prevent expansion of damage in advance. Specifically, the security management unit executes an abnormal value detection algorithm using unsupervised learning. The system generates a multidimensional feature amount vector combining packet header information of network traffic, a call history of an application programming interface, and an operation log of a user as input data. The system inputs a hash value of a transmission source IP address and a continuous value indicating a call frequency as specific examples. The abnormality detection model projects a real-time input vector onto a space in which a distribution of normal access patterns has been learned. The model calculates a Mahalanobis distance and a reconstruction error from the learned distribution. The model generates a threat level score for each transaction as output data. The system outputs an integer value from 0 to 100 as a specific example. The model outputs a contribution degree vector of a feature amount determined to be abnormal. The system determines whether or not the threat level score exceeds a set threshold value as subsequent processing. The system automatically drops communication from the corresponding IP address at a firewall level when the threshold value is exceeded. The system transmits an incident response prompt to a terminal of the administrator. The system blocks a zero-day attack, which cannot be detected by conventional signature-based security, in units of milliseconds by an autonomous judgment of a computer. The system ensures robustness of the system and enhances data protection.

A terminal side provides an interface for a site person in charge to confirm and input an inventory status and a work instruction in real time from a tablet terminal or a smartphone, and for an administrator to browse KPIs and a risk status on a dashboard from a notebook computer and receive an alert notification. On the terminal side, a report and a dashboard distributed from the server are displayed, and a user can input a comment and feedback as necessary. For example, the site person in charge inputs an inventory stocktaking result from the terminal, and the information is immediately reflected in the integrated database on the server side, whereby real-time data update becomes possible. Furthermore, in response to an inquiry or an instruction in a natural language from the terminal (for example, “tell me an inventory risk of main products this week”, “display an operating status of transport robots today in a graph”, etc.), the generative AI on the server side automatically executes optimal data extraction and analysis processing, and an interactive dialogue function of returning an easy-to-understand answer and report to the terminal side can also be realized. For example, when the site person in charge inputs “tell me products whose inventory is likely to be short in zone B”, the AI lists them based on demand prediction and inventory data, and automatically generates a replenishment instruction. Specifically, the interface and the interactive inquiry unit on the terminal side execute a hybrid architecture that links a lightweight large language model operating on an edge device and an inference engine on a cloud. The system acquires a text character string input by the user from a touch panel of the terminal as input data. The system acquires voice waveform data input from a microphone as input data. The system inputs a token array of a natural language query “tell me products whose inventory is likely to be short in zone B” as a specific example. The model on the edge side executes intent classification and entity extraction of the query with low delay. The system transfers the extracted vector to the model on the cloud side when complex data analysis is required. The model on the cloud side searches a vector database, combines demand prediction data and inventory data, and generates an answer. The model generates character string data of an answer text in a natural language as output data. The model outputs graph data indicating a related inventory transition. The system renders the answer text as a chat bubble on a screen of the terminal as subsequent processing. The system passes the graph data to a drawing engine to display an interactive chart. The system enables a site worker to immediately access an advanced data analysis result only by a natural language without learning a complex search query. The system dramatically improves work efficiency and quality of decision making at a site.

In addition, data such as temperature, humidity, and position information acquired in real time from IoT sensors are also automatically collected and integrated on the server side, and the generative AI utilizes these data to immediately determine a quality deterioration risk, for example, at the time of a temperature abnormality in a refrigerated zone, and can automatically transmit an emergency response instruction to the terminal of the site person in charge. Furthermore, when data linkage is performed between a plurality of logistics centers, the generative AI automatically learns differences in data formats and business processes of respective bases and generates an optimal data conversion/linkage logic, thereby realizing rapid and safe data sharing. For example, delivery date information and quality information from an overseas supplier can be automatically captured and immediately reflected in a domestic shipping plan. Specifically, the system adopts a deep learning architecture equipped with a self-attention mechanism in order to process time-series data acquired from an environment sensor. The server divides temperature, humidity, and position information indicating three-dimensional coordinates for each certain time window. The server extracts the divided data as an input vector having 5 dimensions. The server connects a plurality of input vectors in chronological order to generate a two-dimensional time-series tensor. The generative artificial intelligence receives this time-series tensor as input data. The generative artificial intelligence extracts a feature amount indicating a temporal dependency relationship through a multi-layered neural network. The generative artificial intelligence generates an abnormality probability score, which is a continuous value from 0 to 1 indicating a quality deterioration risk, as output data. For example, a case is assumed where the input data indicates a temperature transition rapidly rising from a reference value of minus 20 degrees. The generative artificial intelligence outputs an extremely high abnormality probability score of 0.95. The system compares this output score with a preset threshold value of 0.8. The system determines that the score has exceeded the threshold value. The system immediately transmits a control signal instructing an emergency response to a mobile terminal of the site person in charge as subsequent processing. Thereby, the system realizes abnormality detection in units of milliseconds without depending on human visual monitoring. The system exhibits a technical effect of dramatically reducing a disposal loss due to quality deterioration. Furthermore, the system autonomously executes a schema mapping process for performing data linkage between a plurality of logistics centers. The generative artificial intelligence receives metadata of a database of each base and a text representation of a sample record as inputs. The generative artificial intelligence utilizes an advanced inference function of a large language model. The generative artificial intelligence outputs a mapping rule indicating a correspondence relationship between different data structures. For example, the generative artificial intelligence determines that a character string “delivery date” of base A and a character string “scheduled arrival date and time” of base B point to the same concept. The generative artificial intelligence outputs an executable conversion script for converting both into a unified format. The system automatically applies this conversion script to a subsequent data extraction, transformation, and loading process. Thereby, the system significantly reduces man-hours required for manual system integration development. The system dramatically improves immediacy of data sharing in a heterogeneous mixed environment. The system automatically converts even atypical text data from an overseas supplier into structured data. The system supplies data to a domestic shipping planning system without delay, and enhances visibility of the entire supply chain.

As described above, in the embodiment of the present invention, the respective units of data integration, demand prediction, optimization planning, report generation, and security management are mainly realized on the server side, the generative AI is utilized as an essential element for automation, optimization, and sophistication processing of each unit, and a user interface, data input/browsing, a notification function, an interactive dialogue function, and the like are realized on the terminal side, whereby data integration, demand prediction, plan optimization, real-time analysis, report generation, and security management of the entire logistics center can be automated and sophisticated in an end-to-end manner, and operational efficiency improvement at a site, cost reduction, inventory optimization, rapid decision making, and competitiveness enhancement can be realized. Specifically, the system adopts a distributed processing architecture in which edge computing and cloud computing are fused. The server is composed of a plurality of calculation nodes equipped with parallel arithmetic processing devices. The server centrally executes learning and inference processing of an artificial intelligence model that requires a huge amount of matrix operations. The terminal is configured as a portable device equipped with a lightweight processor. The terminal operates specialized in data collection and result display. The system minimizes consumption of a network bandwidth by this role sharing. The system dramatically improves a response speed of the entire system. The generative artificial intelligence constantly monitors a data stream flowing between the respective processing units. The generative artificial intelligence automatically shapes normalized data output from the data integration unit as an input tensor to the demand prediction unit. The generative artificial intelligence converts probability distribution data output from the demand prediction unit as a constraint condition vector to the optimization planning unit. The system seamlessly executes data conversion between these modules without human intervention. Thereby, the system integrates business processes that have been conventionally divided as a single continuous calculation pipeline. The system shortens a delay time from data input to final decision making from several hours to several seconds. The system acquires an ability to immediately adapt to a sudden fluctuation occurring in operation of the logistics center. The system exhibits a technical effect of dynamically adjusting excess and deficiency of inventory and simultaneously minimizing a storage cost and a shortage risk. The system converts planning work that has depended on human experience and intuition into a pure mathematical optimization problem. The system forcibly applies data-driven objective decision making. The system functions as a fundamental technology that fundamentally enhances competitiveness of the entire company.

### System Configuration

The system according to the present embodiment comprises a data integration unit, a demand prediction unit, an optimization planning unit, a report generation unit, a security management unit, a user interface unit, and a site equipment linkage unit. The data integration unit is a unit that automatically collects and integrates data from diverse data sources inside and outside the logistics center in real time or in batches, and for example, acquires inventory data for each zone from a barcode reader, an RFID reader, an inventory management system, a picking cart, and an AGV in real time, acquires warehousing and delivery histories from a warehouse management system and a transportation and delivery management system by API linkage, acquires an operating status, a current position, a remaining battery level, failure information, and an operating history of a transport robot from a robot management system and a robot main body via MQTT and REST API, acquires a shift and an operating status of a worker, a work start/end time, work contents, and a qualification, skill, health condition, and fatigue level of a worker from a site terminal and a wearable device, automatically acquires delivery schedule data from the outside and order data from a customer by EDI, WebAPI, and FTP file linkage, periodically acquires traffic information and weather information from an external service API, and collects environmental data such as temperature, humidity, vibration, illuminance, noise, air quality, position information, weight, door opening/closing, and full/empty information of an inventory shelf from an IoT sensor via MQTT and HTTP in real time. The data integration unit performs automatic conversion of column names, units, and date formats, deduplication, missing value imputation, and abnormal value detection on these heterogeneous data, and even when an unknown data format or a new data source is added, the generative AI learns past data structures and conversion rules, and automatically generates an optimal mapping and conversion logic. For example, by causing the generative AI to read a prompt “Please normalize the following inventory, transport, and worker data in different formats for an integrated database. Please also automatically perform correspondence of column names, unification of date formats, conversion of numerical units, imputation of missing values, and detection and correction of abnormal values.”, automatic integration of unknown data becomes possible. Specifically, the data integration unit operates on a parallel calculation cluster composed of a plurality of calculation nodes. The data integration unit buffers raw data collected from heterogeneous data sources in a temporary storage device. The data integration unit extracts metadata and the first 100 sample records from the raw data. The data integration unit converts the extracted data into a text character string of a natural language. The data integration unit configures this text character string as an input prompt to a large language model. The large language model adopts a transformer architecture having billions of parameters equipped with a self-attention mechanism. Input data to the large language model is a sequence of embedded vector representations of words. For example, the input data includes a character string “product code” of system A and a character string “SKU” of system B. The large language model calculates similarity of contextual meanings of these character strings as cosine similarity on a high-dimensional space. The large language model determines that both point to the same concept. The large language model outputs a structured text describing a conversion rule for normalization as output data. For example, the output data includes an instruction to map the “SKU” column of system B to the “product_id” column of the integrated database. The data integration unit parses this output data. The data integration unit dynamically reconfigures a data conversion pipeline based on a result of the parsing. The data integration unit executes a batch conversion process for all subsequent records using the reconfigured pipeline. Thereby, the system completely eliminates conventional work in which a human manually creates a mapping definition. The system dramatically shortens a system modification lead time when adding a new data source from several weeks to several minutes. The system acquires an ability to autonomously adapt even to an unknown data format. The system exhibits a technical effect of dramatically improving robustness and scalability of data integration processing.

The demand prediction unit is a unit that extracts multidimensional feature amounts such as past shipping performance, inventory transition, order tendency, seasonality, weather, traffic conditions, promotion history, event information, competitive trends, and consumer behavior data for each product, each zone, and each date from the integrated database, automatically extracts factors affecting demand using the generative AI, and automatically generates and optimizes an optimal time-series prediction model or deep learning model. For example, for a product whose demand increases on weekends and holidays, calendar information and regional event information are extracted as feature amounts, for a product whose demand rapidly increases when weather deteriorates, demand prediction using a weather forecast is performed, and an influence of a promotion measure or a price change on demand is also reflected in the model as a causal relationship. The generative AI automatically selects an optimal prediction method according to product characteristics and zone characteristics, and autonomously executes feature engineering and hyperparameter tuning. For example, by causing the generative AI to read a prompt “Please predict shipping demand for each item, each zone, and each date based on the following shipping performance data, inventory data, order data, weather data, and traffic data. Please automatically extract factors affecting demand and generate an optimal prediction model.”, automatic generation of a demand prediction model becomes possible. Specifically, the demand prediction unit adopts a long short-term memory network or a transformer-based time-series prediction architecture. The demand prediction unit digitizes the multidimensional data extracted from the integrated database. The demand prediction unit configures daily data for the past 30 days as a three-dimensional tensor having three dimensions of a batch size, a sequence length, and a feature amount dimension. The demand prediction unit supplies this three-dimensional tensor as input data to an artificial intelligence model. For example, the feature amount dimension of the input tensor includes a continuous value indicating a past sales quantity, a one-hot vector of a categorical variable indicating a day of the week, and a numerical value indicating a precipitation amount. The artificial intelligence model executes a self-attention operation on the input tensor. The artificial intelligence model learns a hidden correlation between events separated in time. The artificial intelligence model generates a one-dimensional vector indicating a predicted demand amount for each day for the next 7 days as output data. The artificial intelligence model simultaneously outputs not only a simple point estimate value but also a parameter of a probability distribution indicating uncertainty of prediction. For example, the output data includes a parameter of a normal distribution that tomorrow's demand for a specific product has an average of 150 and a standard deviation of 12. The demand prediction unit uses a mean squared error as a loss function in order to minimize a prediction error. The demand prediction unit iteratively updates a weight parameter of a network using a gradient descent method. The demand prediction unit transfers the generated prediction vector to the subsequent optimization planning unit. Thereby, the system realizes highly accurate demand prediction that does not rely on human intuition. The system accurately captures a fluctuation in demand even in a situation where external factors such as weather and events are complexly intertwined. The system exhibits a technical effect of simultaneously reducing both an increase in a storage cost due to excess inventory and an opportunity loss due to a shortage. The system also includes a meta-learning function that dynamically changes a structure of the prediction model itself according to data.

The optimization planning unit is a unit that simultaneously executes inventory arrangement optimization, transport route optimization, worker assignment optimization, and shipping order optimization by a multi-objective optimization algorithm using the generative AI with diverse parameters such as a demand prediction result, a current inventory amount, an operating status of transport robots, a shift of workers, an empty space in each zone, a shipping deadline time, a congestion status of a transport route, a remaining battery level of a robot, a skill and fatigue level of a worker, a qualification of a worker, a type and capability of a transport robot, a work history of a worker, and an emergency response rule as inputs, and calculates in real time an optimal plan that realizes maximization of overall transport efficiency, leveling of work load, prevention of shortage and retention, and rapid response at the time of abnormality. For example, flexible optimization in line with an actual situation of a site becomes possible, such as assigning a short-distance transport task when the battery of the transport robot is low, automatically proposing a break when the fatigue level of the worker is high, and cooperatively assigning a plurality of robots and a plurality of workers when a sudden large order occurs. For example, by causing the generative AI to read a prompt “Please simultaneously execute inventory arrangement optimization, transport route optimization, worker assignment optimization, and shipping order optimization based on the following demand prediction data, inventory data, robot operating status, worker shift, and transport route information, and automatically generate an optimal plan that realizes maximization of overall transport efficiency, leveling of work load, prevention of shortage and retention, and rapid response at the time of abnormality.”, automatic generation of an optimization plan becomes possible. Specifically, the optimization planning unit adopts a hybrid architecture combining deep reinforcement learning and a graph neural network. The optimization planning unit models a physical layout in the logistics center as a graph structure composed of nodes and edges. The optimization planning unit expresses a current state of each node as a feature amount vector. The optimization planning unit combines a demand prediction tensor, a state vector of a robot, and a state vector of a worker. The optimization planning unit configures the combined data as a high-dimensional state tensor indicating a current environment state. A reinforcement learning agent receives this state tensor as an input. The reinforcement learning agent searches for an optimal action using a policy gradient method. The reinforcement learning agent generates a two-dimensional assignment matrix indicating resource assignment for each task as output data. For example, rows of the output matrix represent tasks, and columns represent available robots or workers. Each element of the matrix is a continuous value from 0 to 1 indicating a probability of assignment. The optimization planning unit applies a greedy method or a Viterbi algorithm to this probability matrix. The optimization planning unit generates a final confirmed schedule sequence. The reinforcement learning agent learns using a reward function obtained by weighting and adding a plurality of objective functions of minimization of transport time, leveling of battery consumption, and reduction of worker fatigue level. The optimization planning unit converts the generated schedule sequence into a control command group for the subsequent site equipment linkage unit. Thereby, the system solves a scheduling problem in which a huge number of combinations exist within a practical calculation time. The system discovers a global optimal solution that cannot be reached by rule-based heuristics. The system exhibits a technical effect of recalculating and adapting a plan within several seconds even for a sudden machine failure or a sudden order change. The system maximizes processing throughput of the entire logistics center to the utmost limit.

The report generation unit is a unit that automatically creates diverse analysis reports such as a current inventory status, a transport plan, a worker assignment, a shipping schedule, an abnormality detection result, KPI progress, transport efficiency, a work load, a delay risk, a CO2 emission amount, a worker operating rate, a transport robot operating rate, and a delivery date compliance rate using the generative AI, automatically generates a work instruction report for a site person in charge and an operation summary report for an administrator, and distributes the reports to a site terminal or a dashboard. For example, a specific work instruction such as “transport from zone A to zone C is assigned to robot R1 this morning, and worker W2 is in charge of picking in a shipping area” is automatically generated for the site person in charge, and an operation summary such as “transport efficiency of this week is improved by 10% compared to the previous week, a delay risk is reduced, and the number of abnormality occurrences is zero” is automatically distributed to the administrator. For example, by causing the generative AI to read a prompt “Please automatically generate a work instruction report for a site person in charge and an operation summary report for an administrator based on the following optimization plan data, inventory data, and transport performance data. Please express an analysis result in an easy-to-understand manner with graphs and sentences.”, automatic generation of a report becomes possible. Specifically, the report generation unit adopts a large language model specialized in natural language generation technology. The report generation unit collects numerical data and categorical data output from each module in the system. The report generation unit converts these data into a structured data format having key-value pairs. The report generation unit flattens this structured data into a one-dimensional token sequence. The large language model receives this token sequence as input data. For example, the input data includes information such as a numerical value “85 percent” indicating transport efficiency and a flag “false” indicating a delay risk. The large language model sequentially calculates an appearance probability of a next word using a decoder block of a transformer. The large language model generates a text character string described in a natural language easy for a human to understand as output data. For example, the output data includes a sentence “The operating rate of robot R1 exceeds a target value, and overall transport efficiency is improved compared to the previous week”. Furthermore, the report generation unit automatically calculates a graph drawing parameter necessary for data visualization in parallel with text generation. The report generation unit combines the output text character string and the graph drawing parameter. The report generation unit renders the combined data into a display format such as HTML or PDF. The report generation unit transmits the rendered report to the subsequent user interface unit. Thereby, the system completely eliminates time for a data scientist or an analyst to manually create a report. The system immediately verbalizes a real-time situation change and transmits it to a person concerned. The system provides information of an optimal granularity according to each role from a site worker to a management layer. The system exhibits a technical effect of accelerating decision-making speed of the entire organization. The system automatically converts an enumeration of numerical values into a meaningful business insight.

The security management unit is a unit that applies a strict security policy such as data access authority management, encryption, audit log recording, abnormal access detection, data masking, data backup, a disaster recovery plan, and legal and regulatory compliance, and realizes dynamic and autonomous security management, such as generative AI automatically detecting an unauthorized access pattern from an access log, dynamically optimizing access authority according to a data usage status, and automatically identifying and warning of a location with a high data leakage risk. For example, by causing the generative AI to read a prompt “Please analyze the following access log data and automatically detect unauthorized access and abnormal behavior. Please identify a high-risk location and automatically generate an alert text to an administrator.”, automation of security monitoring becomes possible. Specifically, the security management unit adopts an anomaly detection ensemble model combining an autoencoder and an isolation forest algorithm. The security management unit collects raw access logs output from network devices and servers in real time. The security management unit extracts attributes such as an IP address of an access source, a requested URL, a payload size, and an access time. The security management unit digitizes these attributes and generates a feature vector having 50 dimensions. The anomaly detection model receives this feature vector as input data. The autoencoder performs processing of compressing the input vector into a low-dimensional latent space and then reconstructing it to the original dimension. The anomaly detection model calculates a Euclidean distance between the input vector and the reconstructed vector as a reconstruction error. The anomaly detection model outputs this reconstruction error as an anomaly score. For example, assume a case where a large number of database queries are executed from an unknown overseas IP address outside normal business hours. The anomaly detection model determines that it deviates significantly from a past normal pattern, and outputs an extremely high anomaly score. The security management unit compares the output anomaly score with a dynamically fluctuating threshold value. When the score exceeds the threshold value, the security management unit immediately issues a control command to block communication from the IP address to a firewall as subsequent processing. At the same time, the security management unit automatically generates a warning text explaining an outline of the incident using a large language model. The security management unit push-notifies this warning text to a terminal of a system administrator. Thereby, the system prevents a zero-day attack and internal fraud that cannot be detected by a conventional signature-based security measure. The system shortens a time from detection of a security incident to initial response to a millisecond unit. The system exhibits a technical effect of reducing a leakage risk of confidential data to the utmost limit. The system breaks through a limit of log monitoring by a human security analyst.

The user interface unit is a unit that provides an interface for a site person in charge to confirm and input an inventory status and a work instruction in real time from a tablet terminal or a smartphone, and for an administrator to browse KPIs and a risk status on a dashboard and receive an alert notification from a notebook personal computer. On the terminal side, a report and a dashboard distributed from the server are displayed, and a user can input a comment and feedback as necessary. For example, the site person in charge inputs an inventory taking result from the terminal, and the information is immediately reflected in the integrated database on the server side, whereby real-time data update becomes possible. Furthermore, in response to an inquiry or an instruction in natural language from the terminal (for example, “Tell me the inventory risk of major products this week”, “Display the operating status of transport robots today in a graph”, etc.), the generative AI on the server side automatically executes optimal data extraction and analysis processing, and an interactive dialogue function of returning an easy-to-understand answer or report to the terminal side can also be realized. For example, by causing the generative AI to read a prompt “In response to a question from a user ‘Tell me products whose inventory is likely to be short in zone B’, please answer risk factors and countermeasures in an easy-to-understand text based on the latest inventory data and demand prediction data.”, automatic generation of an interactive response becomes possible. Specifically, the user interface unit includes an interactive processing engine implementing a retrieval-augmented generation architecture. The user interface unit receives a natural language query of the user input from a microphone or a keyboard of the terminal. The user interface unit tokenizes the query using a natural language processing model. The user interface unit converts the token sequence into an embedding vector in a high-dimensional space. The interactive processing engine receives this embedding vector as an input. The interactive processing engine executes a similarity search on a vector database. The interactive processing engine extracts a context vector of the latest inventory data and prediction result related to the query. The interactive processing engine combines the user's query vector and the extracted context vector. The interactive processing engine inputs the combined vector to the large language model. The large language model generates an accurate answer text based on facts as output data based on the context information. For example, the output data includes a specific proposal that “For a specific product in zone B, the probability that the inventory will be depleted at 2:00 PM tomorrow is 80 percent. It is recommended to move a substitute from zone C.” Furthermore, the large language model simultaneously outputs a structured command set for a front-end application to draw a graph together with the text answer. The user interface unit dynamically renders the received text and command set on a screen of the terminal as subsequent processing. Thereby, the system enables the user to intuitively interact with the system without learning a complex SQL query or operation procedure. The system significantly reduces a cognitive load required for information retrieval. The system exhibits a technical effect of supporting a site worker to take a rapid action based on data. The system fundamentally improves a human-machine interface.

The site equipment linkage unit is a unit that links site equipment such as a transport robot, an IoT sensor, a barcode reader, an RFID reader, a picking cart, an AGV, and a wearable device with the server system, and for example, distributes an operation instruction and route information of the transport robot from the server to the robot, feeds back an operating status and abnormality information from the robot to the server, transmits real-time data such as temperature, humidity, vibration, and position information from the IoT sensor to the server, transmits performance data of inventory movement and warehousing/delivery from the barcode reader and the RFID reader to the server, transmits work progress and position information from the picking cart and the AGV to the server, and transmits biological information and a work status of a worker from the wearable device to the server. For example, by causing the generative AI to read a prompt “Please monitor the operating status of the site equipment in real time based on the following robot operation data, IoT sensor data, and picking cart data, and automatically generate an alert at the time of abnormality.”, automatic monitoring and control of the site equipment linkage becomes possible. Specifically, the site equipment linkage unit adopts a hierarchical edge artificial intelligence architecture combining primary processing on an edge device side and advanced inference on the server side. The site equipment linkage unit executes a lightweight inference model on a microcontroller incorporated in each site equipment. The site equipment linkage unit continuously samples a high-frequency raw data stream output from the sensor. The site equipment linkage unit configures the sampled data as an input tensor of a one-dimensional array. The edge inference model receives this input tensor and extracts a local feature using a convolutional neural network. The edge inference model outputs a scalar value indicating a degree of deviation from a normal state. For example, when vibration data of a motor of the transport robot is input, the edge inference model detects a minute frequency change indicating a sign of bearing wear, and outputs an abnormality flag. The site equipment linkage unit transmits detailed waveform data to the server side only when the abnormality flag is true. The generative artificial intelligence on the server side receives the received waveform data as an input. The generative artificial intelligence collates with a past failure history database, and outputs a classification label specifying a root cause of the failure. The site equipment linkage unit generates a control command vector commanding the robot to evacuate to a safe place and stop as subsequent processing, and transmits it via a network. Thereby, the system reduces consumption of a network bandwidth to a fraction of several tens compared to a conventional method of transmitting all raw data to the server. The system realizes real-time control in a millisecond unit without being affected by a communication delay. The system exhibits a technical effect of preventing a fatal failure of the equipment and minimizing downtime. The system constructs a scalable autonomous control network in which a large number of IoT devices operate cooperatively.

As described above, the system according to the present embodiment can realize operational efficiency improvement, cost reduction, inventory optimization, rapid decision making, and competitiveness enhancement of site operation by automating and sophisticating data integration, demand prediction, optimization planning, real-time analysis, report generation, security management, a user interface, and site equipment linkage of the entire logistics center in an end-to-end manner by operating each unit in cooperation and utilizing the generative AI as an essential element for automation, optimization, and sophistication processing of each unit. Specifically, the system functions as a multi-agent system in which a plurality of independent artificial intelligence models mutually exchange data. The system transfers a normalized tensor generated by the data integration unit to the demand prediction unit and the optimization planning unit with zero copy via a shared memory space. The system reduces an overhead of inter-process communication to the utmost limit by this optimization of memory access. The system distributes inference processing of each artificial intelligence model to a large number of cores of a parallel arithmetic processing device and executes it asynchronously. The system continuously maps a probability distribution vector of demand prediction and a real-time state vector from the site equipment to an input space of a reinforcement learning agent of the optimization planning unit. The reinforcement learning agent updates an action value function in real time following a dynamic change in an environment. The reinforcement learning agent continuously outputs a control command matrix that maximizes throughput of the entire system. The system converts this control command matrix into an operation of a physical actuator through the site equipment linkage unit. Thereby, the system directly connects an advanced calculation result in a cyber space to efficient material handling in a physical space. The system solves a constraint condition of a complex supply chain at a scale and speed exceeding limits of human cognitive ability and processing speed. The system dramatically improves information processing efficiency of a computer system itself, not limited to mere computerization and automation of business. The system exhibits a technical effect of achieving overall optimization of logistics operations while maximizing utilization efficiency of calculation resources. The system provides an innovative technology foundation for realizing a data-driven autonomous supply chain.

### Implementation Steps

### Step 1: Data Collection/Integration Step

Inventory data, warehousing and delivery histories, an operating status of transport robots, a shift and operating status of workers, an external delivery schedule, a customer order, traffic information, weather information, and IoT sensor data (temperature, humidity, vibration, illuminance, noise, air quality, position information, weight, door opening/closing, inventory shelf full/empty information, etc.) are automatically collected in real time or in batches from diverse data sources inside and outside the logistics center, and aggregated to the server by diverse means such as API linkage, file linkage, MQTT, HTTP, and site terminal input. The data integration unit performs automatic conversion of column names, units, and date formats, deduplication, missing value imputation, and abnormal value detection, and even when an unknown data format or a new data source is added, the generative AI learns a past data structure and conversion rule, and automatically generates an optimal mapping and conversion logic. A specific example of a prompt text to be read by the generative AI is “Please normalize the following inventory, transport, and worker data in different formats for an integrated database. Please also automatically perform mapping of column names, unification of date formats, conversion of numerical units, imputation of missing values, and detection and correction of abnormal values.” Specifically, the system adopts a lambda architecture that executes stream processing and batch processing in parallel in a data collection pipeline. The data integration unit temporarily stores sensor data arriving at a high frequency in a ring buffer on a memory using a message queuing system. The data integration unit cuts out a data chunk of a certain size from the ring buffer. The data integration unit configures this data chunk as a two-dimensional matrix of N rows and M columns. The generative artificial intelligence receives this two-dimensional matrix as input data. The generative artificial intelligence statistically analyzes a data type and distribution of each element in the matrix. When a missing value exists, the generative artificial intelligence calculates an imputation value by a K-nearest neighbor method or an autoregressive model using surrounding data points. The generative artificial intelligence generates a clean two-dimensional matrix in which all missing values are imputed and outliers are smoothed as output data. For example, when the input matrix includes a missing value of a temperature sensor, the generative artificial intelligence outputs a matrix in which a temperature value estimated from a past trend and data of an adjacent sensor is embedded. The data integration unit writes this clean matrix to a designated table of a distributed database at high speed as subsequent processing. Thereby, the system automatically converts incomplete or noisy raw data into a high-quality tensor that can be directly processed by a subsequent machine learning model. The system significantly reduces a calculation cost and time required for data preprocessing. The system exhibits a technical effect of preventing a decrease in accuracy of a prediction model caused by variation in data quality. The system integrates data arriving asynchronously by diverse protocols as a single reliable information source.

### Step 2: Demand Prediction Model Generation/Execution Step

Multidimensional feature amounts such as past shipping performance, inventory transition, order tendency, seasonality, weather, traffic conditions, promotion history, event information, competitive trends, and consumer behavior data are extracted for each product, each zone, and each date from the integrated database, factors affecting demand are automatically extracted using the generative AI, and an optimal time-series prediction model or deep learning model is automatically generated and optimized. For example, calendar information and regional event information are incorporated as feature amounts for a product whose demand increases on weekends and holidays, and a weather forecast is incorporated as a feature amount for a product whose demand rapidly increases when weather deteriorates. A specific example of a prompt text to be read by the generative AI is “Please predict shipping demand for each item, each zone, and each date based on the following shipping performance data, inventory data, order data, weather data, and traffic data. Please automatically extract factors affecting demand and generate an optimal prediction model.” Specifically, the system executes a learning phase and an inference phase of demand prediction separately. The demand prediction unit divides history data extracted from the integrated database into a learning data set and a verification data set. The demand prediction unit shapes the learning data set into a three-dimensional tensor having a batch size of 64, a sequence length of 30, and a feature amount dimension of 20. The deep learning model receives this three-dimensional tensor as an input. The deep learning model is composed of a plurality of gated recurrent unit layers and fully connected layers. The deep learning model forward-propagates the input tensor and calculates a hidden state vector at each time step. The deep learning model generates a prediction value vector indicating a future demand amount as a final output. The demand prediction unit calculates a mean absolute error between the prediction value vector and an actual correct label as a loss function. The demand prediction unit calculates a gradient of a weight matrix in a network using an error backpropagation method. The demand prediction unit iteratively updates the weight matrix using an Adam optimizer to minimize a value of the loss function. In the inference phase, the demand prediction unit configures the latest data of the most recent 30 days as a similar three-dimensional tensor, and inputs it to the learned model. The model outputs a one-dimensional vector having 7 elements indicating a daily demand prediction for the next one week. The demand prediction unit writes this prediction vector to a constraint condition database of the optimization planning unit as subsequent processing. Thereby, the system accurately models a non-linear demand fluctuation pattern that cannot be captured by a classical method such as linear regression. The system significantly improves prediction accuracy compared to a conventional method. The system exhibits a technical effect of minimizing a risk of over-ordering or out-of-stock based on a mathematical basis. The system also provides an online learning function of continuously fine-tuning a weight of the model according to a change in an external environment.

### Step 3: Inventory/Transport/Worker Assignment Optimization Step

With diverse parameters such as a demand prediction result, a current inventory amount, an operating status of transport robots, a shift of workers, an empty space in each zone, a shipping deadline time, a congestion status of a transport route, a remaining battery level of a robot, a skill, fatigue level, and qualification of a worker, a type and capability of a transport robot, a work history of a worker, and an emergency response rule as inputs, inventory arrangement optimization, transport route optimization, worker assignment optimization, and shipping order optimization are simultaneously executed by a multi-objective optimization algorithm using the generative AI, and an optimal plan that realizes maximization of transport efficiency, leveling of work load, prevention of shortage and retention, and rapid response at the time of abnormality is calculated in real time. For example, when the battery of the transport robot is low, short-distance transport is assigned, when the fatigue level of the worker is high, a break is automatically proposed, and at the time of a sudden large order, a plurality of robots and a plurality of workers are cooperatively assigned. A specific example of a prompt text to be read by the generative AI is “Please simultaneously execute inventory arrangement optimization, transport route optimization, worker assignment optimization, and shipping order optimization based on the following demand prediction data, inventory data, robot operating status, worker shift, and transport route information, and automatically generate an optimal plan that realizes maximization of overall transport efficiency, leveling of work load, prevention of shortage and retention, and rapid response at the time of abnormality.” Specifically, the system activates a dedicated solver engine for solving a constrained non-linear optimization problem. The optimization planning unit loads a demand prediction vector, a state vector indicating a current state of resources, and an inequality group indicating physical constraint conditions onto a memory. The optimization planning unit integrates these data to construct a huge input state space having hundreds of dimensions. The generative artificial intelligence receives this input state space as a search space. The generative artificial intelligence executes a hybrid search combining an evolutionary algorithm and a gradient method. The generative artificial intelligence calculates fitness of each individual (solution candidate) using an evaluation function combining a sum of transport distances, battery consumption, and variance of an operating rate of workers. The generative artificial intelligence applies crossover and mutation operators to iteratively generate a generation of solutions with higher fitness. The generative artificial intelligence outputs the best individual converged within a predetermined calculation time as an optimized schedule matrix. For example, the output schedule matrix has a structure in which an assigned robot ID, a scheduled start time, and a scheduled end time are mapped to each task ID. The optimization planning unit decomposes this schedule matrix into individual control commands as subsequent processing, and asynchronously transmits them to each site equipment via a message broker. Thereby, the system discovers a Pareto optimal solution that simultaneously satisfies a plurality of conflicting objective functions at high speed. The system generates a schedule that a human planner took several hours to create in several seconds. The system exhibits a technical effect of reducing idle time of resources to the utmost limit and maximizing throughput of the entire logistics center. The system dynamically repairs the schedule by immediately performing recalculation even for a disturbance such as a delay or a failure that occurred during execution.

### Step 4: Report Generation/Site Distribution Step

Diverse analysis reports such as a current inventory status, a transport plan, a worker assignment, a shipping schedule, an abnormality detection result, KPI progress, transport efficiency, a work load, a delay risk, a CO2 emission amount, a worker operating rate, a transport robot operating rate, and a delivery date compliance rate are automatically created using the generative AI, a work instruction report for a site person in charge and an operation summary report for an administrator are automatically generated, and distributed to a site terminal or a dashboard. For example, a specific work instruction such as “Transport from zone A to zone C is assigned to robot R1 this morning, and worker W2 is in charge of picking in a shipping area” is automatically generated for the site person in charge, and an operation summary such as “Transport efficiency this week improved by 10% compared to the previous week, delay risk decreased, and the number of abnormality occurrences is zero” is automatically distributed to the administrator. A specific example of a prompt text to be read by the generative AI is “Please automatically generate a work instruction report for a site person in charge and an operation summary report for an administrator based on the following optimization plan data, inventory data, and transport performance data. Please express an analysis result in an easy-to-understand manner with a graph or a text.” Specifically, the system executes a report generation pipeline as periodic batch processing. The report generation unit extracts operation performance data for the past 24 hours and the schedule matrix generated by the optimization planning unit from the database. The report generation unit aggregates these data and calculates a numerical vector indicating various KPIs. The report generation unit combines this numerical vector and an identifier of a predefined report template to configure an input data set. The large language model receives this input data set. The large language model analyzes a fluctuation trend and an abnormal value of numerical data using a self-attention mechanism. The large language model generates a text document structured in a markdown format as output data. For example, the output document includes a heading, a bulleted summary, and a detailed analysis paragraph. The report generation unit parses this text document and extracts an embedded graph drawing tag. The report generation unit dynamically generates image data of a line graph or a pie chart based on the extracted tag. The report generation unit generates a final report file integrating the text and the image as subsequent processing, and push-distributes it to a terminal of a designated user. Thereby, the system completely automates a series of processes from data aggregation to visualization and addition of interpretation by natural language. The system eliminates information asymmetry and significantly reduces a communication cost between a site and a management layer. The system exhibits a technical effect of improving quality of decision making of the entire organization by rapidly sharing an objective fact based on data. The system seamlessly realizes report sharing between global bases by incorporating a multilingual translation model.

### Step 5: Security Management/Audit Step

A strict security policy such as data access authority management, encryption, audit log recording, abnormal access detection, data masking, data backup, a disaster recovery plan, and legal and regulatory compliance is applied, and the generative AI automatically detects an unauthorized access pattern from an access log, dynamically optimizes access authority according to a data usage status, and automatically identifies and warns of a location with a high data leakage risk. For example, when a specific user downloads a large amount of data from a time zone or a place different from usual, the generative AI detects abnormal behavior and immediately issues an alert to an administrator. A specific example of a prompt text to be read by the generative AI is “Please analyze the following access log data and automatically detect unauthorized access and abnormal behavior. Please identify a high-risk location and automatically generate an alert text to an administrator.” Specifically, the system constantly operates a real-time stream processing engine for security monitoring. The security management unit continuously collects access logs output from all API gateways and databases in the system via a message broker. The security management unit extracts a user ID, a session ID, an operation type, and a data transfer amount from each log entry. The security management unit normalizes these features and generates a feature vector having 32 dimensions. The anomaly detection model receives this feature vector as an input. The anomaly detection model holds a hidden state vector obtained by learning a past behavior sequence of a user using a long short-term memory network. The anomaly detection model compares a current input vector and the hidden state vector, and calculates a degree of deviation from predicted normal behavior. The anomaly detection model generates an anomaly probability score in a range of 0 to 1 as output data. For example, when a user whose normal download amount is several megabytes requests several gigabytes of data at midnight, the model outputs an extremely high score of 0.99. The security management unit immediately invalidates an authentication token of a session whose score exceeds a threshold value and forcibly disconnects communication as subsequent processing. At the same time, the security management unit writes an audit log entry recording details of the incident to a storage with a tamper-proof function. Thereby, the system autonomously blocks an advanced targeted attack or an internal crime that slips through rule-based detection before damage expands. The system dramatically reduces a monitoring load of a security administrator. The system exhibits a technical effect of maintaining availability and confidentiality of the system at a high level. The system continuously improves detection accuracy of the model by using a detected abnormal pattern as relearning data.

Step 6: User Interface/Interactive Inquiry Step An interface is provided for a site worker to confirm and input an inventory status and a work instruction in real time from a tablet terminal or a smartphone, and for an administrator to browse KPIs and a risk status on a dashboard from a laptop computer and receive an alert notification. An interactive dialog function is also realized in which, in response to an inquiry or an instruction in natural language from a terminal (for example, “Tell me the inventory risk of major products this week”, “Display the operating status of transport robots today in a graph”, etc.), the generative AI on the server side automatically executes optimal data extraction and analysis processing, and returns an easy-to-understand answer or report to the terminal side. A specific example of a prompt sentence to be read by the generative AI is “In response to a question from a user ‘Tell me products whose inventory in zone B is likely to be short’, please answer risk factors and countermeasures in an easy-to-understand sentence based on the latest inventory data and demand prediction data.” Specifically, the system executes distributed processing combining speech recognition on an edge side and natural language understanding on a server side in order to minimize latency of interactive processing. The terminal samples a user's voice input and converts voice waveform data into a text character string. The terminal transmits this text character string to the server as a lightweight JSON payload. An interactive processing engine of the server receives this text character string as input data. The interactive processing engine converts the text into a word embedding vector. The interactive processing engine executes a high-speed vector similarity search on an in-memory database using this vector. The interactive processing engine extracts a snippet of related data obtained as a search result. The interactive processing engine combines the user's question vector and the extracted data snippet, and inputs them to a large language model. The large language model generates an answer text in natural language as output data after understanding the context. For example, the output data includes a text “For a specific product in zone B, the probability that the inventory will be depleted at 2:00 PM tomorrow is 80 percent”. The interactive processing engine returns this answer text to the terminal as subsequent processing. The terminal displays the received text on a screen and reproduces it as voice using a voice synthesis engine. Thereby, the system enables hands-free information access even in a site work environment where keyboard input is difficult. The system eliminates the need for the user to learn complex system operations. The system exhibits a technical effect of shortening the time to reach necessary information from several minutes to several seconds. The system collects user feedback and continuously fine-tunes the response accuracy of the dialog model.

### Specific Use Case

For example, consider a case where the logistics center operation optimization system of the present invention is applied to a large-scale logistics center having a plurality of logistics bases and deploying automatic transport robots, IoT sensors, and worker terminals at each base. At each base, inventory data is collected in real time from barcode readers, RFID readers, inventory management systems, picking carts, AGVs, and the like, and warehousing and delivery histories are acquired from warehouse management systems and transportation and delivery management systems by API linkage. The operating status, current position, remaining battery level, failure information, and operation history of the transport robots are acquired from a robot management system or the robot main body via MQTT or REST API, and the shift, operating status, work start/end time, work content, qualification/skill/health condition/fatigue level, and the like of workers are acquired from site terminals and wearable devices. Delivery schedule data and customer order data from the outside are automatically acquired by EDI, Web API, and FTP file linkage, and traffic information and weather information are periodically acquired from external service APIs. Environmental data such as temperature, humidity, vibration, illuminance, noise, air quality, position information, weight, door opening/closing, and inventory shelf full/empty information are collected in real time from the IoT sensors. Specifically, the system constructs a distributed messaging cluster in order to process large-scale data traffic. The system receives raw data streams transmitted from tens of thousands of devices via edge gateways arranged at the respective bases. The edge gateway classifies the received data for each protocol and serializes the data into a standardized binary format. The edge gateway configures the serialized data as a one-dimensional byte array. The system asynchronously transfers this byte array to a data lake on a cloud. The data lake writes the received byte array to a distributed file system together with a time stamp and a device ID. In this writing process, the system executes a hash value calculation for eliminating data duplication. The system suppresses consumption of storage capacity by discarding data packets having matching hash values. As subsequent processing, the system supplies the stored data to an extract, transform, load pipeline of the data integration unit. Thereby, the system realizes reliable data collection while preventing packet loss even in an environment where network bandwidth is limited. The system provides a robust data collection infrastructure having no single point of failure. The system exhibits a technical effect of linearly scaling out simply by adding nodes even when the number of devices increases in the future. The system captures all events in a physical space as digital data without omission, and enables construction of a highly accurate digital twin in a cyber space.

The data integration unit performs automatic conversion of column names, units, and date formats, deduplication, missing value imputation, and abnormal value detection on these diverse data, and even when an unknown data format or a new data source is added, the generative AI automatically generates an optimal mapping and conversion logic based on a prompt “Please normalize the following inventory, transport, and worker data in different formats for the integrated database. Please also automatically perform mapping of column names, unification of date formats, conversion of numerical units, missing value imputation, and detection and correction of abnormal values.”, and stores the data in the integrated database. Specifically, the data integration unit executes an advanced data processing pipeline combining metadata management and automatic schema inference. The data integration unit expands a raw data set extracted from the data lake on a memory. The data integration unit extracts statistical feature amounts and a distribution of data types from each column of the data set. The data integration unit configures these feature amounts as a metadata vector having 128 dimensions. The generative artificial intelligence receives this metadata vector and a text representation of a sample record as inputs. The generative artificial intelligence analyzes a contextual meaning of the input data using an encoder layer of a transformer architecture. The generative artificial intelligence generates a structured mapping definition file defining a conversion rule for each column as output data. For example, the output mapping definition file includes an instruction of a function call for converting string-type date data into an integer-type UNIX timestamp. The data integration unit parses this mapping definition file and dynamically compiles an executable data conversion code. The data integration unit applies parallel conversion processing to the entire data set spanning millions of rows using the compiled code. As subsequent processing, the data integration unit inserts the clean data after conversion into a designated table of the integrated database. Thereby, the system completely automates a conventional process in which a data engineer manually writes an ETL script. The system immediately adapts to a specification change or a new addition of a data source without downtime. The system exhibits a technical effect of dramatically shortening a lead time required for data integration from several days to several minutes. The system continuously provides a high-quality and consistent data set to a subsequent machine learning model at all times.

The demand prediction unit extracts multidimensional feature amounts such as past shipping performance, inventory transition, order tendency, seasonality, weather, traffic conditions, promotion history, event information, competitive trends, and consumer behavior data for each product, each zone, and each date from the integrated database, and the generative AI automatically extracts factors affecting demand and automatically generates and optimizes an optimal time-series prediction model or deep learning model based on a prompt “Please predict shipping demand for each item, each zone, and each date based on the following shipping performance data, inventory data, order data, weather data, and traffic data. Please automatically extract factors affecting demand and generate an optimal prediction model.” For example, calendar information and regional event information are incorporated as feature amounts for products whose demand increases on weekends and holidays, and weather forecasts are incorporated as feature amounts for products whose demand rapidly increases when weather deteriorates. Specifically, the demand prediction unit adopts an ensemble learning architecture combining a plurality of different algorithms. The demand prediction unit shapes the multidimensional data extracted from the integrated database into a three-dimensional tensor having three dimensions of a batch size, a sequence length, and a feature amount dimension. The demand prediction unit simultaneously inputs this three-dimensional tensor to three independent predictors: a gradient boosting decision tree model, a long short-term memory network model, and a transformer model. Each predictor extracts features from the input tensor from different viewpoints, and independently outputs a one-dimensional vector indicating a future demand amount. The generative artificial intelligence functions as a meta-learner that receives these three output vectors as inputs. The generative artificial intelligence dynamically calculates a weighting coefficient based on a past prediction error of each predictor. The generative artificial intelligence generates a final highly accurate demand prediction vector subjected to weighted addition as output data. For example, the output vector indicates a daily demand amount of a specific product for the next 7 days by a floating-point number. As subsequent processing, the demand prediction unit transfers this final prediction vector to an input buffer of the optimization planning unit. Thereby, the system accurately captures a complex and non-linear demand fluctuation pattern that cannot be handled by a single model. The system maximizes generalization performance for unknown data while preventing overfitting. The system exhibits a technical effect of reducing a prediction error by several tens of percent compared to a conventional method. The system enables proactive inventory replenishment based on precise demand prediction, and raises the efficiency of the entire supply chain.

The optimization planning unit simultaneously optimizes inventory arrangement, a transport route, worker assignment, and a shipping order by automatically generating a multi-objective optimization algorithm based on a prompt “Please simultaneously execute inventory arrangement optimization, transport route optimization, worker assignment optimization, and shipping order optimization based on the following demand prediction data, inventory data, robot operating status, worker shift, and transport route information, and automatically generate an optimal plan that realizes maximization of overall transport efficiency, leveling of work load, prevention of shortage and retention, and rapid response at the time of abnormality.” by the generative AI, with diverse parameters such as a demand prediction result, a current inventory amount, an operating status of transport robots, a shift of workers, an empty space in each zone, a shipping deadline time, a congestion status of a transport route, a remaining battery level of a robot, a skill/fatigue level/qualification of a worker, a type/capacity of a transport robot, a work history of a worker, and an emergency response rule as inputs. For example, when the battery of a transport robot is low, short-distance transport is assigned, when the fatigue level of a worker is high, a break is automatically proposed, and at the time of a sudden large order, a plurality of robots and a plurality of workers are cooperatively assigned. Specifically, the optimization planning unit adopts a multi-agent reinforcement learning architecture in which a plurality of autonomous agents operate cooperatively. The optimization planning unit expands a demand prediction vector, a state vector indicating a current position and a remaining battery level of each robot, and a skill matrix of workers on a memory. The optimization planning unit combines these data to construct a huge state tensor indicating a current snapshot of the entire logistics center. The reinforcement learning model receives this state tensor as an input. The reinforcement learning model calculates a probability distribution of actions to be taken by each agent (robot or worker) using an actor-critic method. The reinforcement learning model generates an action matrix indicating a specific task assignment and a movement route for each agent as output data. For example, the output action matrix includes a vector instructing robot A to move from shelf B to picking station C. The optimization planning unit verifies at high speed on a simulator whether this action matrix causes a physical collision or a constraint violation. As subsequent processing, the optimization planning unit converts the verified action matrix into individual control commands, and transmits them to a site equipment linkage unit. Thereby, the system generates an overall optimized schedule in real time in a complex environment where thousands of devices and hundreds of workers coexist. The system prevents local congestion and resource conflict in advance. The system exhibits a technical effect of maximizing shipping processing capacity per unit time of the logistics center. The system recalculates the plan in units of milliseconds in accordance with a change in situation, and always maintains an optimal operation state.

The report generation unit automatically generates diverse analysis reports such as a current inventory status, a transport plan, a worker assignment, a shipping schedule, an abnormality detection result, KPI progress, transport efficiency, a work load, a delay risk, a CO2 emission amount, a worker operating rate, a transport robot operating rate, and a delivery date compliance rate by the generative AI based on a prompt “Please automatically generate a work instruction report for a site worker and an operation summary report for an administrator based on the following optimization plan data, inventory data, and transport performance data. Please express analysis results in an easy-to-understand manner using graphs and sentences.”, and distributes the reports to a site terminal or a dashboard. For example, a specific work instruction such as “Transport from zone A to zone C is assigned to robot R1 this morning, and worker W2 is in charge of picking in the shipping area” is automatically generated for the site worker, and an operation summary such as “Transport efficiency this week improved by 10% compared to the previous week, delay risk decreased, and the number of abnormality occurrences is zero” is automatically distributed to the administrator. Specifically, the report generation unit includes a natural language processing engine having a large language model as a core. The engine receives multidimensional tensor data output from the optimization planning unit as an input. The system acquires an inventory amount vector, a robot operating rate matrix, and a time-series array of delay probability scores as input data. The processing unit executes preprocessing for converting these numerical data into a text embedding vector. The neural network has an encoder and decoder structure based on a transformer architecture. The model automatically extracts an index having high importance from the input multidimensional data using a self-attention mechanism. The AI model outputs structured text data and a coordinate data array for graph drawing based on the extracted feature amounts. The system generates a work instruction text, a KPI summary text, and plot points for a graph as output data. The processing unit transmits the generated output text to a rendering engine. The rendering engine dynamically generates a markup language code for dashboard display based on the received text and coordinate data. The system distributes the generated code to the site terminal as a push notification. With this configuration, the system eliminates manual report creation work by a human. The system reduces latency of report generation to the order of milliseconds. The system completely prevents human errors such as misinterpretation of numerical data and input mistakes. The system optimizes consumption of calculation resources and reduces a processing load on the server. The present technology functions extremely effectively as a real-time information sharing system in a large-scale logistics center or a manufacturing factory. The system can also adopt an ensemble learning method in which a plurality of language models are operated in parallel. The system continuously updates weights of the model using a dedicated evaluation function for evaluating accuracy of the output text. The system reuses a past report generation history as learning data to autonomously improve output quality.

The security management unit applies a strict security policy such as data access authority management, encryption, audit log recording, abnormal access detection, data masking, data backup, a disaster recovery plan, and legal compliance, and the generative AI automatically detects an unauthorized access pattern from an access log, dynamically optimizes an access authority in accordance with a data usage status, and automatically specifies and warns of a location having a high data leakage risk based on a prompt “Please analyze the following access log data and automatically detect unauthorized access and abnormal behavior. Please specify a high-risk location and automatically generate an alert sentence to an administrator.” Specifically, the security management unit adopts a composite AI architecture combining a time-series abnormality detection model and a large language model for alert generation. The system acquires a time-series array of access logs collected from network devices and a server group as input data. The processing unit extracts a multidimensional vector including a source IP address, a time stamp, an access destination resource ID, and a payload size as input data. The system executes one-hot encoding on categorical data. The system applies normalization processing to numerical data so as to have zero mean and unit variance. The neural network has an autoencoder structure and learns a latent space representation of a normal access pattern. The model compresses an input vector into a low-dimensional space, and then reconstructs it to the original dimension. The processing unit calculates a reconstruction error between the input vector and the reconstructed vector. When the calculated reconstruction error exceeds a preset threshold value, the system determines that the access is abnormal. The system inputs the access feature vector determined to be abnormal to the language model for alert generation. The AI model generates an abnormality score of a floating-point number ranging from zero to one and an alert text in natural language as output data. As a specific example of the output, the system outputs a score of 0.95 and a text “Large amount of data download from unapproved IP in midnight time zone detected”. When the abnormality score exceeds a danger threshold value, the processing unit automatically transmits an immediate block command to a firewall control module. The system updates a dynamic access control list in real time to prevent expansion of damage. With this configuration, the system detects an unknown cyber attack or internal fraud in real time. The system significantly shortens a response time to a security incident. The system reduces a monitoring load on an administrator and realizes complete automation of system protection. The present technology is applicable as an information leakage prevention system in a data center of a financial institution or a research facility handling confidential information. The system also provides a variation in which a time-series dependency relationship is learned more deeply using a recurrent neural network.

In the user interface unit, a site worker confirms and inputs an inventory status and a work instruction in real time from a tablet terminal or a smartphone, and an administrator browses KPIs and a risk status on a dashboard from a laptop computer and receives an alert notification. An interactive dialog function is realized in which, in response to an inquiry or an instruction in natural language from a terminal (for example, “Tell me the inventory risk of major products this week”, “Display the operating status of transport robots today in a graph”, etc.), the generative AI on the server side automatically executes optimal data extraction and analysis processing based on a prompt “In response to a question from a user ‘Tell me products whose inventory in zone B is likely to be short’, please answer risk factors and countermeasures in an easy-to-understand sentence based on the latest inventory data and demand prediction data.”, and returns an easy-to-understand answer or report to the terminal side. Specifically, the user interface unit includes an interactive processing engine integrating a natural language processing model and a query generation module. The system receives a speech recognition result or a text input character string transmitted from a user terminal as input data. The processing unit acquires a character string “Tell me the inventory risk in zone B”, a user ID, and metadata of a current time as input data. The system executes morphological analysis on the input character string. The system removes unnecessary stop words and performs preprocessing for converting the character string into a token string. The neural network extracts a user's intent using an intent classification model. The model specifies an entity necessary for search using a slot filling technique. The system inputs the extracted intent and entity to a language model. The AI model automatically generates a structured query language code or an application programming interface call command for searching a database. The processing unit accesses the integrated database using the generated query, and extracts necessary information. The system re-inputs the extracted information to the language model, and generates an answer in natural language. The AI model generates an answer text and a data array for graph drawing as output data. As a specific example of the output, the system outputs an answer text “The probability that the inventory of product X will be depleted tomorrow is 80 percent” and a numerical array for drawing a bar graph. The processing unit transmits the generated answer text to a voice synthesis module, and converts it into voice data. The system transmits the voice data and the graph data to the user terminal, and renders them on the user interface via a screen drawing engine. With this configuration, the system dramatically improves a response speed to an atypical user query. The system abstracts a complex database operation and dramatically improves user operability. The system realizes rich information provision while suppressing consumption of a communication band. The present technology is extremely useful as a hands-free work support system in a warehouse or a decision-making support dashboard for a management layer. The system can also implement a memory mechanism that holds a past dialog history of a user as a context and generates a more accurate answer.

As described above, in the site operation of the logistics center, by automating and sophisticating data integration, demand prediction, optimization planning, report generation, security management, and a user interface using the generative AI in an end-to-end manner, it is possible to realize improvement of an inventory turnover rate, maximization of transport efficiency, leveling of work load, prevention of shortage and retention, rapid response at the time of abnormality occurrence, and labor saving and sophistication of site work. Specifically, the system adopts a microservice architecture in which respective functional modules cooperate via an asynchronous messaging queue. The system integrally monitors multidimensional stream data flowing through the entire system. The processing unit acquires a sensor data stream output from each module and a time-series array of transaction logs as input data. The system aggregates these stream data in real time, and executes preprocessing for generating a state vector of the entire system. The neural network functions as a meta-reinforcement learning model for maximizing throughput of the entire system. The model receives the state vector as an input, and dynamically calculates an optimal hyperparameter of each module. The AI model generates a throughput optimization parameter group of the entire system as output data. As a specific example of the output, the system outputs a window size of batch processing and an allocation ratio of calculation resources in a parallel calculation cluster. The processing unit transmits the output parameter group to a container orchestration tool. The tool dynamically scales the calculation resource of each microservice based on the received parameters. With this configuration, the system maximizes calculation efficiency of the entire system. The system minimizes a communication load between modules and prevents depletion of a network band. The system significantly reduces end-to-end data processing latency. The system autonomously achieves global optimization instead of local optimization. The present technology is applicable as an integrated management platform of a global supply chain or an autonomous control system of a wide-area logistics infrastructure in a smart city. The system can also incorporate an environmental index such as minimization of power consumption or reduction of a carbon dioxide emission amount as a reward function of reinforcement learning. Even when a hardware failure occurs, the system instantaneously executes a failover mechanism for automatically taking over processing to a normal node based on determination by the AI. The system realizes a completely autonomous computer system that continuously executes self-repair and self-optimization without requiring any human intervention.

The specific processing unit 290 sends the results of specific processing obtained in Example 1 or Application Example 1 described above to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence).

An example of the data generation model 58 is a generative AI such as ChatGPT (registered trademark) (Internet search <URL:https://openai.com/blog/chatgpt>).

The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart device 14.

### Second Embodiment

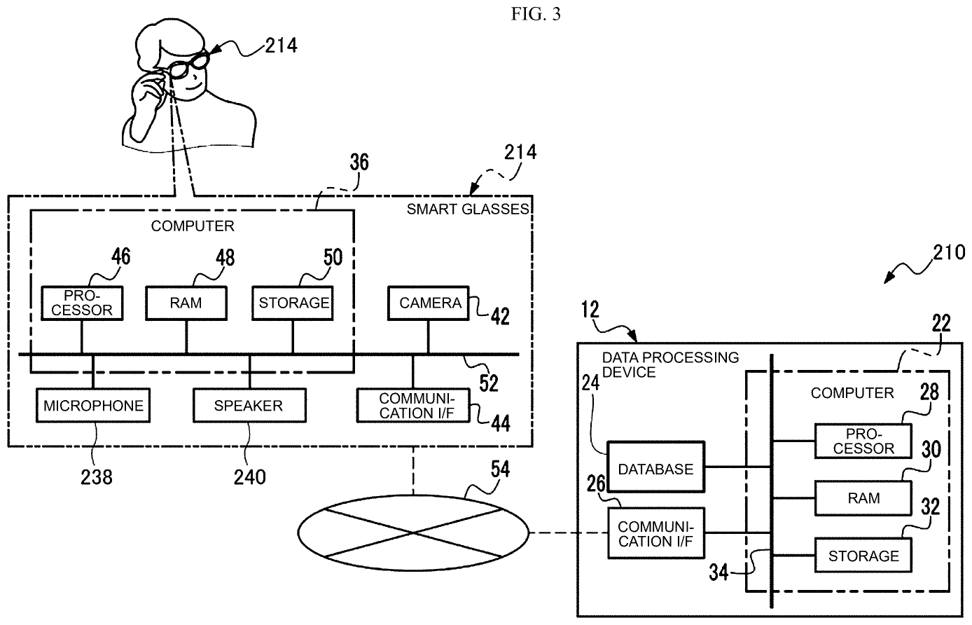

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, camera 42, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

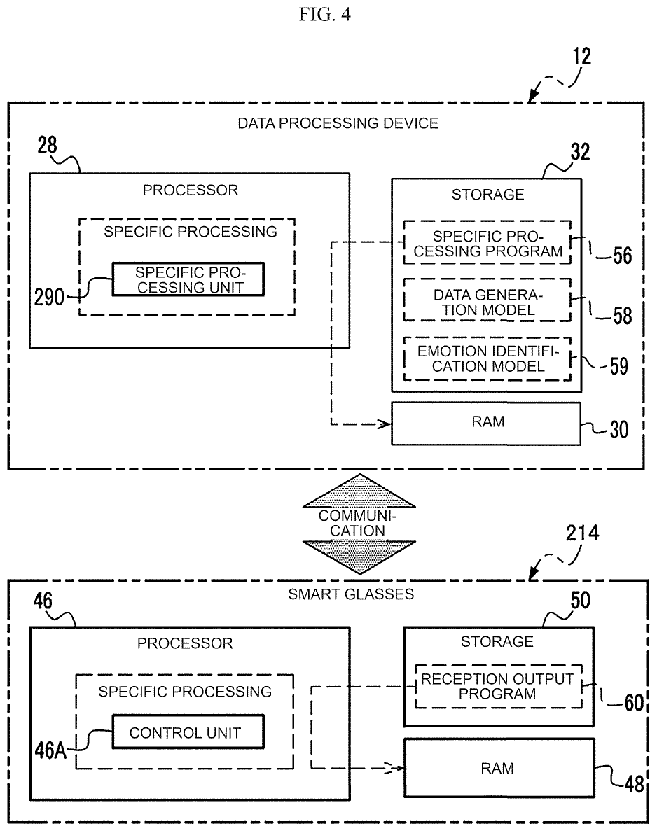

FIG. 4 shows an example of the main functions of the data processing device 12 and smart glasses 214. As shown in FIG. 4, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart glasses 214, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48. The smart glasses 214 may also have similar data generation models and emotion identification models as the data generation model 58 and emotion identification model 59, and perform the same processing as the specific processing unit 290 using these models.

Next, specific processing by the specific processing unit 290 of the data processing device 12 will be described. Each part of the system described below is realized by the data processing device 12 and the smart glasses 214. In the following description, the data processing device 12 is referred to as a “server,” and the smart glasses 214 are referred to as a “terminal.”

### Example 1

Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart glasses 214.

### Third Embodiment

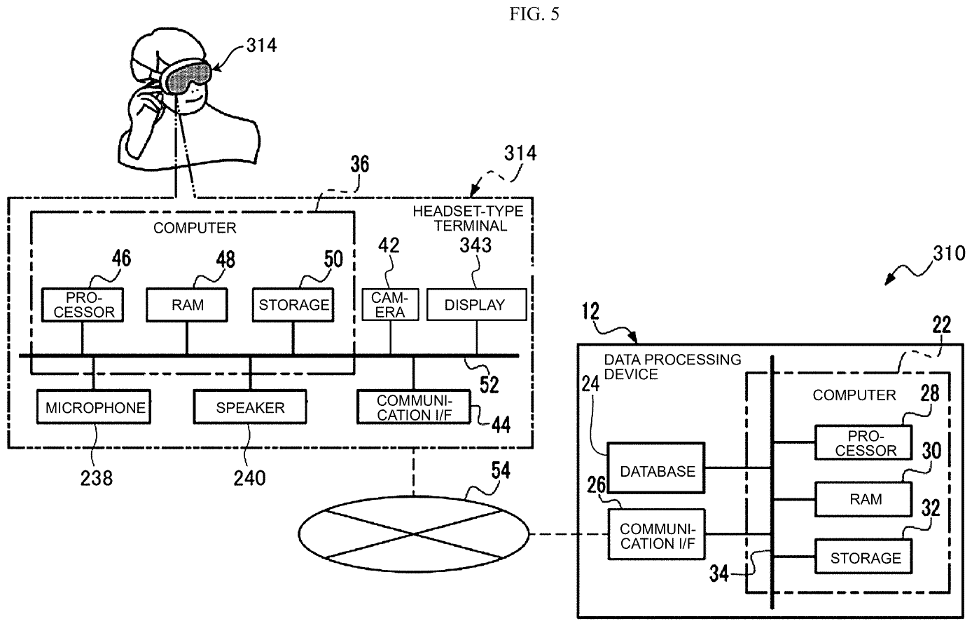

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, display 343, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

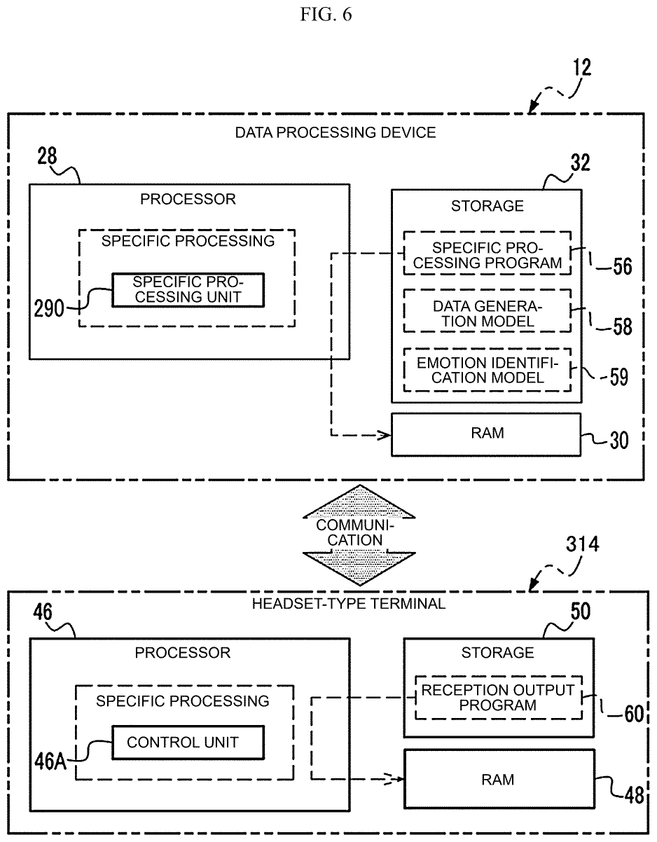

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the headset-type terminal 314, reception output processing is performed by the processor 46.

The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the headset-type terminal 314. In the following description, the data processing device 12 is referred to as a “server,” and the headset-type terminal 314 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

In the above embodiments, an example form where specific processing is performed by the data processing device 12 was described, but the technology disclosed herein is not limited to this, and specific processing may be performed by the headset-type terminal 314.

### Fourth Embodiment

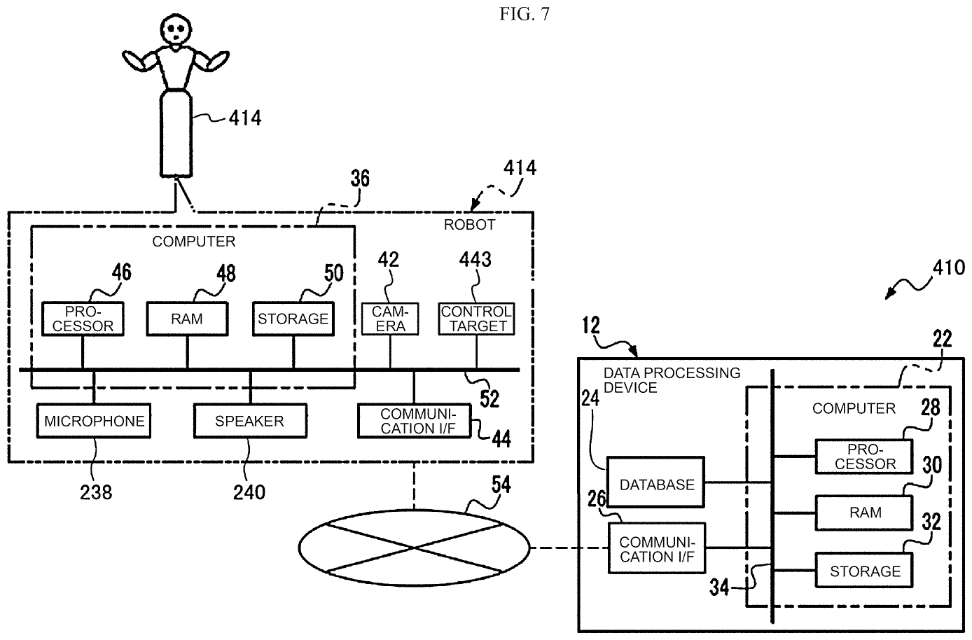

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, control target 443, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

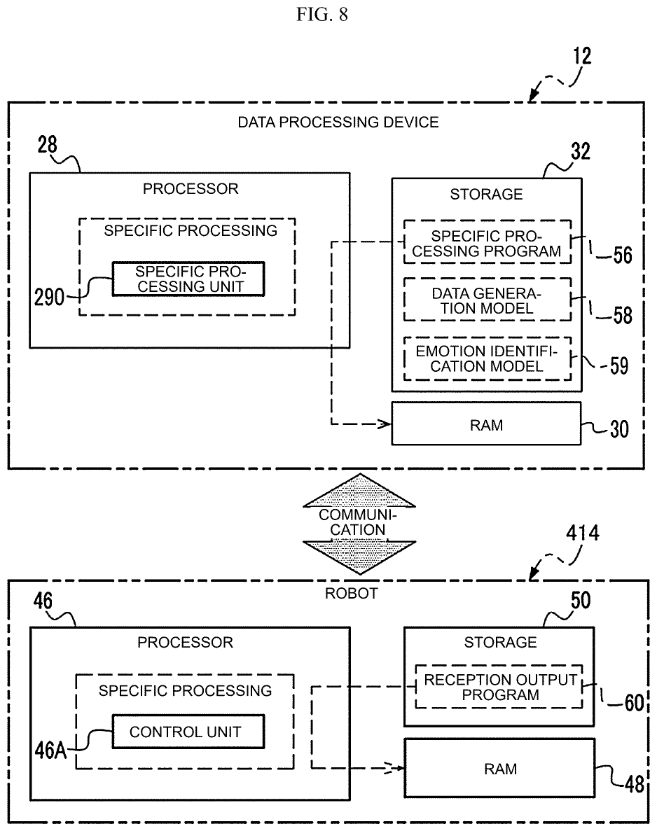

FIG. 8 shows an example of the main functions of the data processing device 12 and the robot 414. As shown in FIG. 8, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the robot 414, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the robot 414. In the following description, the data processing device 12 is referred to as a “server,” and the robot 414 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

In the above embodiments, an example form where specific processing is performed by the data processing device 12 was described, but the technology disclosed herein is not limited to this, and specific processing may be performed by the robot 414.

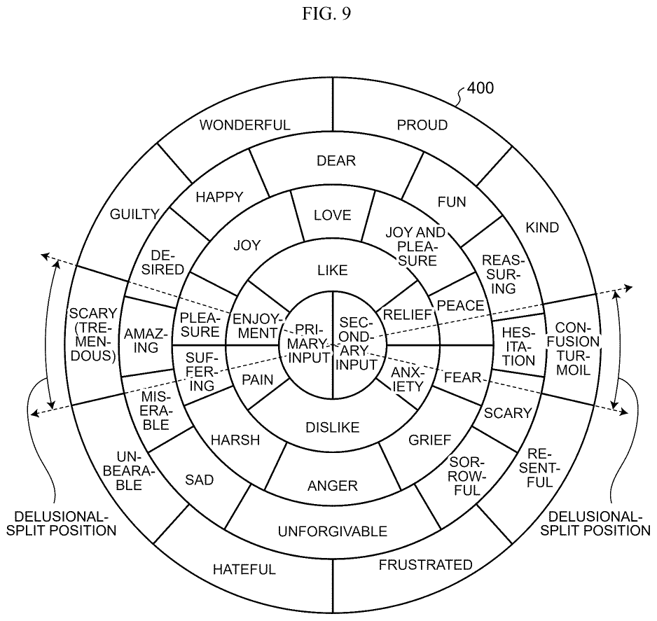

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o′clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

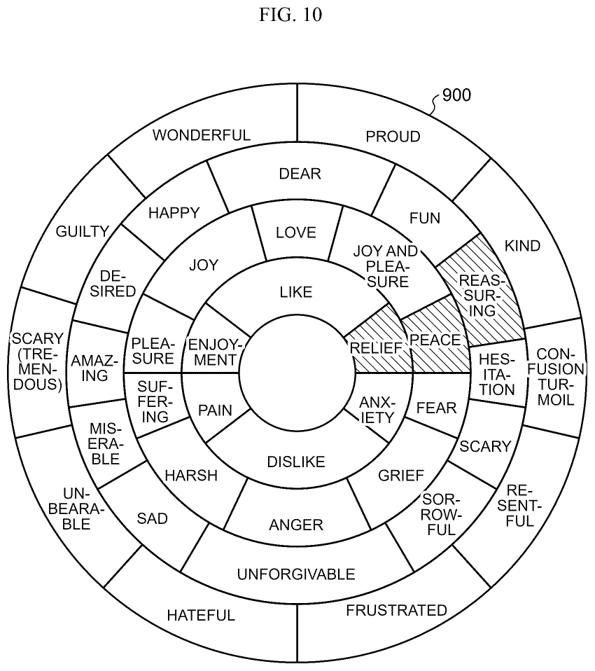

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above, the system according to the present disclosure has been described mainly on the functions of the data processing device 12, but the system according to the present disclosure is not necessarily mounted on a server. The system according to the present disclosure may be implemented as a general information processing system. The present disclosure may be implemented, for example, as a software program running on a personal computer, or an application running on a smartphone or the like. The method according to the present disclosure may be provided to the user in the form of SaaS (Software as a Service).

In the above embodiments, an example form where specific processing is performed by a single computer 22 was described, but the technology disclosed herein is not limited to this, and distributed processing for specific processing by multiple computers including the computer 22 may be performed. For example, the data generation model 58 may be provided in an external device of the data processing device 12, and the external device may generate data corresponding to the input data.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned.

Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

Note that the following supplementary notes are further disclosed regarding the above description.

### Supplementary Note 1

A logistics center operation optimization system comprising: a data integration unit; a demand prediction unit; an optimization planning unit; a report generation unit; and a security management unit, wherein the data integration unit has a function of automatically collecting inventory data for each zone inside and outside a logistics center, warehousing and delivery histories, operating statuses of transport robots, shift and operating statuses of workers, delivery schedule data from the outside, order data from customers, traffic information, weather information, and environmental data such as temperature, humidity, and vibration by IoT sensors by means such as API linkage, file upload, and real-time stream, performing automatic conversion of column names, units, and date formats, deduplication, missing value imputation, and abnormal value detection, and automatically generating an optimal mapping and conversion logic using generative AI even when an unknown data format or a new data source is added, and storing the data in an integrated database; the demand prediction unit has a function of automatically extracting factors affecting demand using the generative AI based on multidimensional data such as past shipping performance, inventory transition, order tendency, seasonality, weather, traffic conditions, and promotion history from the integrated database, automatically generating and optimizing an optimal time-series prediction model or deep learning model, and predicting future shipping demand and inventory fluctuation with high accuracy; the optimization planning unit has a function of simultaneously executing inventory arrangement optimization, transport route optimization, worker assignment optimization, and shipping order optimization by a multi-objective optimization algorithm using the generative AI with various parameters such as a demand prediction result, a current inventory amount, an operating status of transport robots, a shift of workers, an empty space in each zone, a shipping deadline time, a congestion status of a transport route, a remaining battery level of a robot, and a skill and fatigue level of a worker as inputs, and calculating in real time an optimal plan that realizes maximization of overall transport efficiency, leveling of work load, prevention of shortage and retention, and rapid response at the time of abnormality; the report generation unit has a function of automatically aggregating a current inventory status, a transport plan, a worker assignment, a shipping schedule, an abnormality detection result, KPI progress, transport efficiency, a work load, a delay risk, and the like, automatically generating a work instruction report for a site worker and an operation summary report for an administrator using the generative AI, and distributing the reports to a site terminal or a dashboard; the security management unit has a function of dynamically executing access authority management, encryption, audit log recording, abnormal access detection, and the like by the generative AI to ensure data safety and reliability of site operation; and as a whole, the system is configured to automate and sophisticate data integration, demand prediction, optimization planning, report generation, and security management in site operation of the logistics center in an end-to-end manner with the generative AI as an essential element.

### Supplementary Note 2

The system according to Supplementary Note 1, wherein the demand prediction unit predicts shipping demand for each item, each zone, and each date using the generative AI based on multidimensional data such as past shipping performance, inventory transition, order tendency, seasonality, weather, traffic conditions, and promotion history extracted from the integrated database, automatically extracts factors affecting demand, automatically generates an optimal prediction model, and realizes highly accurate demand prediction dynamically reflecting external factors such as weekends and holidays, weather changes, and promotion measures.

### Supplementary Note 3

The system according to Supplementary Note 1, wherein the optimization planning unit simultaneously optimizes inventory arrangement, a transport route, worker assignment, and a shipping order by a multi-objective optimization algorithm using the generative AI, with various parameters such as a future demand prediction result by the demand prediction unit, a current inventory amount, an operating status of transport robots, a shift of workers, an empty space in each zone, transport route information, a remaining battery level of a robot, and a skill and fatigue level of a worker as inputs, automatically calculates in real time an optimal plan that satisfies a plurality of objectives such as maximization of transport efficiency, leveling of work load, prevention of shortage and retention, and rapid response at the time of abnormality in a well-balanced manner, and feeds back performance data after execution of the plan to continuously improve optimization accuracy.

What is claimed is:

1. A system comprising:
circuitry configured to:
receive, via a communication interface coupled to a packet-switched network, sensor data streams from IoT sensor devices distributed across a logistics facility, three-dimensional point cloud data from light detection and ranging sensors, and structured data records from external data service interfaces, and store the received data in a storage device;
apply a digital twin architecture by replicating events in a physical space to a digital space in real time, updating a three-dimensional virtual environment model with the received sensor data streams and three-dimensional point cloud data, and maintaining a real-time correspondence between physical state variables and virtual state variables;
apply a demand prediction model to historical transaction data records and feature vectors extracted from the structured data records to generate a demand forecast data record comprising predicted quantity values for each item-location combination over a configurable forecast horizon;
apply a generative neural network model to the demand forecast data record, current inventory state variables from the digital twin model, and transport network constraint parameters to generate an optimization plan data record comprising inventory replenishment sequences, production scheduling parameters, and delivery route assignments; and
transmit the optimization plan data record and digital twin visualization data to terminal devices via the communication interface.

2. The system according to claim 1, wherein the circuitry is configured to apply a preprocessing pipeline to the structured data records comprising standardization of column naming conventions, date format normalization, numerical unit conversion, and deduplication to generate a standardized integrated database, and extract feature vectors from the standardized integrated database comprising seasonality indicators, external event markers, and promotional activity identifiers.

3. The system according to claim 2, wherein the circuitry is configured to apply a transformer-based time-series model to historical transaction data records and the extracted feature vectors to generate multi-step ahead demand forecast values, compute prediction confidence intervals by applying ensemble prediction aggregation, and incorporate uncertainty bounds as constraint parameters in the optimization plan data record generation.

4. The system according to claim 1, wherein the circuitry is configured to process three-dimensional point cloud data from light detection and ranging sensors to detect objects and compute their positions, volumes, and movement trajectories within the logistics facility, and update corresponding virtual state variable representations in the digital twin model in real time.

5. The system according to claim 4, wherein the circuitry is configured to apply an object detection model to the three-dimensional point cloud data to classify detected objects by type, compute occupancy maps of storage areas in the logistics facility, and update inventory state variable records in the digital twin model based on computed occupancy values.

6. The system according to claim 1, wherein the circuitry is configured to apply an optimization algorithm to the optimization plan data record by solving a constrained resource allocation problem that minimizes total operational cost while satisfying inventory service level constraint parameters and production capacity constraint parameters, and generate an optimal allocation solution comprising replenishment quantities, production batch sizes, and delivery schedules.

7. The system according to claim 6, wherein the circuitry is configured to apply a graph neural network to a transport network graph comprising location nodes and route edges weighted by transport cost and lead time parameters, execute message passing operations to propagate transport feasibility information, and compute optimal delivery route assignments by selecting minimum-cost paths satisfying delivery deadline constraints.

8. The system according to claim 1, wherein the circuitry is configured to acquire traffic condition data, weather condition data, and delivery status data from external data service interfaces via the communication interface, incorporate the acquired external data as dynamic constraint updates in the optimization plan data record generation, and regenerate affected route assignments when external condition data indicates disruptions.

9. The system according to claim 1, wherein the circuitry is configured to execute simulation runs of the optimization plan data record in the digital twin environment to compute projected throughput metrics and inventory service level metrics under the proposed plan, compare projected metrics against performance targets, and generate an alternative optimization plan data record when projected metrics fall below performance targets.

10. The system according to claim 9, wherein the circuitry is configured to generate comparative simulation result data by executing simulation runs for a plurality of alternative optimization plan data records, rank the alternative plans by aggregate projected performance score, and transmit the comparative simulation result data to terminal devices as a ranked plan comparison report.

11. The system according to claim 1, wherein the circuitry is configured to apply a natural language processing model to report request text received from a terminal device via the communication interface, extract report parameter specifications from the request text, and generate a structured report data record comprising demand forecast summaries, optimization plan summaries, and performance metric projections by applying the generative neural network model to the extracted parameters.

12. The system according to claim 1, wherein the circuitry is configured to generate digital twin visualization data from the three-dimensional virtual environment model comprising occupancy heat maps of storage areas, movement trajectory overlays for automated equipment, and color-coded inventory level indicators, and transmit the visualization data as a structured rendering data record to terminal devices.

13. The system according to claim 1, wherein the circuitry is configured to apply a self-learning update procedure to the demand prediction model by generating training pairs from historical demand forecast data records and corresponding validated actual quantity records, and fine-tuning the model to reduce mean absolute percentage error on the most recent forecast window.

14. The system according to claim 1, wherein the circuitry is configured to monitor key performance indicators derived from the digital twin model state against configurable alert threshold parameters, generate an alert data record when a performance indicator crosses an alert threshold, and transmit the alert data record with a recommended response action sequence to terminal devices associated with operational management user identifiers.

15. The system according to claim 1, wherein the circuitry is configured to apply an encryption protocol to data transmissions between IoT sensor devices and the system, and authenticate each sensor device using a device certificate prior to accepting sensor data streams for ingestion into the digital twin environment.

16. The system according to claim 1, wherein the circuitry is configured to store all optimization plan data records, simulation result data, and decision approval records in an audit log data structure with timestamps and user identifiers, and generate a plan performance history report from the audit log data structure by comparing historical optimization plan projections against subsequently observed operational outcome data.

17. The system according to claim 1, wherein the IoT sensor devices and light detection and ranging sensors are distributed across a logistics processing facility, the digital twin architecture maintains a real-time correspondence between physical facility state and virtual environment state, and the optimization plan data record specifies replenishment, production, and delivery parameters for the logistics facility.

18. A system comprising:
circuitry configured to:
receive, via a communication interface coupled to a packet-switched network, sensor data streams from IoT devices, three-dimensional point cloud data from light detection and ranging sensors, and structured data records from external interfaces, and maintain a digital twin environment with real-time physical-virtual state correspondence;
apply a transformer-based time-series model to generate demand forecast data records with prediction confidence intervals;
apply a generative neural network model and a graph neural network to generate optimization plan data records comprising replenishment sequences, production scheduling parameters, and delivery route assignments;
execute simulation runs in the digital twin environment to validate optimization plans and generate comparative scenario results; and
transmit optimization plan data records and digital twin visualization data to terminal devices via the communication interface.

19. The system according to claim 18, wherein the circuitry is configured to apply an object detection model to three-dimensional point cloud data to compute occupancy maps and update inventory state variables in the digital twin model, apply a self-learning update procedure to fine-tune the demand prediction model on validated outcome records, and generate structured report data records by applying the generative neural network model to report parameter specifications extracted from natural language request text.

20. A method comprising:
receiving, via a communication interface coupled to a packet-switched network, sensor data streams from IoT sensor devices, three-dimensional point cloud data from light detection and ranging sensors, and structured data records from external data services, and maintaining a digital twin architecture with real-time physical-virtual state correspondence;
applying a demand prediction model to generate a demand forecast data record comprising predicted quantity values over a forecast horizon;
applying a generative neural network model to the demand forecast data record and current inventory state variables to generate an optimization plan data record comprising replenishment sequences, production scheduling parameters, and delivery route assignments; and
transmitting the optimization plan data record and digital twin visualization data to terminal devices via the communication interface.
